(19) United States
(12) Patent Application Publication
(10) Pub. No.: US 2026/0309347 A1
(43) Pub. Date: Oct. 8, 2026

(54) AIR CLEANER

(71) Applicant: LG ELECTRONICS INC., Seoul (KR)

(72) Inventors: Kunyoung LEE, Seoul (KR); Juhyup Yoon, Seoul (KR); Taesan Kim, Seoul (KR); Bohyun Kim, Seoul (KR); Jaewan Lee, Seoul (KR)

(21) Appl. No.: 19/710,659

(22) Filed: Jun. 17, 2026

Related U.S. Application Data
(63) Continuation-in-part of application No. 18/221,031, filed on Jul. 12, 2023.
(63) Continuation-in-part of application No. 18/221,110, filed on Jul. 12, 2023, now Pat. No. 12,685,954.
(63) Continuation-in-part of application No. 18/221,540, filed on Jul. 13, 2023.
(63) Continuation-in-part of application No. 18/221,589, filed on Jul. 13, 2023.
(63) Continuation-in-part of application No. 19/388,752, filed on Nov. 13, 2025.
Application No. 19/388,752 is a continuation of application No. 18/221,152, filed on Jul. 12, 2023, now Pat. No. 12,529,488.

(30) Foreign Application Priority Data
Jul. 14, 2022 (KR) 10-2022-0087010
Jul. 14, 2022 (KR) 10-2022-0087011
Jul. 14, 2022 (KR) 10-2022-0087014
Jul. 14, 2022 (KR) 10-2022-0087017
Jul. 14, 2022 (KR) 10-2022-0087019

(51) Int. Cl. F24F 8/108; B01D 46/00; F24F 13/20

(52) U.S. Cl. CPC F24F 8/108; B01D 46/0005; B01D 46/0086; F24F 13/20

(57) ABSTRACT

The present invention is related to an air cleaner. The air cleaner of the present invention comprises a first body that an inlet is formed at a peripheral surface thereof and that an outlet is formed above the inlet; a second body disposed above the first body and guiding air discharged from the outlet in a radially outward direction, wherein the second body comprises: a lower cover disposed above the outlet and extending upwardly as it goes in a radially outward direction; a top cover disposed separably to the lower cover; an upper cover disposed between the lower cover and the top cover and comprising a plate and a protruding cover that protrudes upward from the plate, wherein a hole opened in up-down direction is formed at the top cover such that the protruding cover is disposed, wherein a groove is formed at the plate, the groove depressed downward at a periphery of the protruding cover.

### CROSS-REFERENCE TO RELATED APPLICATIONS

This application is a Continuation-In-Part Application of prior U.S. patent application Ser. No. 18/221,031 filed Jul. 12, 2023, which claims priority under 35 U.S.C. § 119 to Korean Patent Application No. 10-2022-0087019 filed Jul. 14, 2022, a Continuation-In-Part Application of prior U.S. patent application Ser. No.18/221,110 filed Jul. 12, 2023, which claims priority under 35 U.S.C. § 119 to Korean Application No. 10-2022-0087011 filed Jul. 14, 2022, a Continuation-In-Part Application of prior U.S. patent application Ser. No. 18/221,540 filed Jul. 13, 2023, which claims priority under 35 U.S.C. § 119 to Korean Application No. 10-2022-0087017 filed on Jul. 14, 2022, a Continuation-In-Part Application of prior U.S. patent application Ser. No.18/221,589 filed Jul. 13, 2023, which claims priority under 35 U.S.C. § 119 to Korean Application No. 10-2022-0087014 filed Jul. 14, 2022, and a Continuation-In-Part Application of prior U.S. patent application Ser. No. 19/388,752 filed Nov. 13, 2025, which is a Continuation Application of prior U.S. patent application Ser. No. 18/221,152 filed Jul. 12, 2023, which claims priority under 35 U.S.C. § 119 to Korean Application No. 10-2022-0087010 filed Jul. 14, 2022. The entire disclosures are hereby incorporated by reference.

### BACKGROUND

### 1. Field

Embodiments may relate to an air cleaner, and more specifically to an air cleaner capable of utilizing a space above the air cleaner.

### 2. Background

The air cleaner is a device that forms an air flow and that increases an air clearness of air in a certain space after filtering the flowing air. The air cleaner may have a filter, and an inlet may be formed at one side thereof and an outlet may be formed at the other side thereof. The air cleaner may form the outlet at an upper side thereof and may discharge the filtered air all around to quickly increase air clearness of an indoor space.

The Gazette KR 10-2021-0137720, the subject matter of which is incorporated herein by reference, discloses a structure in which a fan is disposed above an air cleaner that forms an upward air flow. Since a device changing direction of air is disposed above the outlet which is opened in up-down direction, it may be difficult to utilize a space above the air cleaner.

### BRIEF DESCRIPTION OF THE DRAWINGS

Embodiments may be described in detail with reference to the following drawings in which like reference numerals refer to like elements, and wherein:

FIG. 1 shows a perspective view of an air cleaner according to a first embodiment;

FIG. 2 shows a side view of FIG. 1;

FIG. 3 shows a disassembled state of an air cleaner according to the present disclosure;

FIG. 4 shows a front view of the air purifier according to an embodiment of the present disclosure;

FIG. 5 shows a sectional view of the air cleaner according to the first embodiment of the present invention;

FIG. 6 shows a plan view of the first body according to the first embodiment;

FIG. 7 shows a plan view of the second body according to the first embodiment;

FIG. 8 shows a sectional view cut along line X-X′ in FIG. 7;

FIG. 9 shows a sectional view cut along line Y-Y′ in FIG. 7;

FIG. 10 shows an exploded perspective view of the upper body according to the first embodiment;

FIG. 11 shows a bottom view of the lower cover according to the first embodiment;

FIG. 12 shows a view of another part of the air purifier according to an embodiment of the present disclosure;

FIG. 13 shows a plan view of the lower cover according to the first embodiment;

FIG. 14 shows an exploded perspective view of the coupling part (or coupler) according to the first embodiment;

FIG. 15 (a) and (b) show the hook according to a first embodiment, wherein (a) shows a plan view and (b) shows a side view;

FIG. 16 (a) and (b) show the hook guider according to the first embodiment, wherein (a) shows a bottom view and (b) shows a front view;

FIG. 17 (a) and (b) show the hook button according to the first embodiment, wherein (a) shows a plan view and (b) shows a side view;

FIG. 18 shows a perspective view of the upper cover according to the first embodiment;

FIG. 19 shows a plan view of FIG. 18;

FIG. 20 shows an exploded perspective view of the charging unit (or charger) according to the first embodiment;

FIG. 21 shows a bottom view of the top cover according to the first embodiment;

FIG. 22 shows a sectional view that the disposition of the coupling part is changed from the second body shown in FIG. 8;

FIG. 23 shows a perspective view of the second body according to the second embodiment;

FIG. 24 shows a plan view of FIG. 23;

FIG. 25 shows a view of the part of the air purifier according to an embodiment of the present disclosure;

FIG. 26 shows a cross-sectional view of a part of the air purifier according to an embodiment of the present disclosure;

FIG. 27 shows a side view in one direction of FIG. 23;

FIG. 28 shows a side view in another direction of FIG. 23;

FIG. 29 shows an exploded perspective view of the second body according to the third embodiment;

FIG. 30 (a) and (b) is for explaining the structure of the hole cover included in the second body of the third embodiment, wherein (a) shows a plan view of the first hole cover and (b) shows a plan view of the second hole cover;

FIG. 31 shows an exploded perspective view of the second body according to the fourth embodiment;

FIG. 32 shows a sectional view for explaining the coupling relationship of the second body of the fourth embodiment;

FIG. 33 shows the air cleaner equipped with the second body according to the fifth embodiment;

FIG. 34 shows the air cleaner equipped with the second body according to the sixth embodiment;

FIG. 35 shows a perspective view of the air cleaner at which the base supporter according to the first embodiment is added to the air cleaner according to the first embodiment;

FIG. 36 shows a side view of FIG. 35;

FIG. 37 shows a perspective view of the air cleaner at which the base supporter according to the second embodiment is added to the air cleaner according to the first embodiment;

FIG. 38 is a sectional view of FIG. 37;

FIG. 39 shows a cross-sectional view of a portion of the air purifier according to an embodiment of the present disclosure;

FIG. 40 shows a cross-sectional view of a part of the air purifier according to an embodiment of the present disclosure;

FIG. 41 (a) to (c) shows a diagram explaining functional attributes of the air purifier according to an embodiment of the present disclosure;

FIG. 42 shows a cross-sectional view of the second body;

FIG. 43 shows an enlarged cross-sectional view illustrating a dotted line portion of FIG. 42

FIG. 44 shows a top plan view of a button module according to the present disclosure; and

FIG. 45 shows a bottom view of a button module according to the present disclosure.

### DETAILED DESCRIPTION

Advantages and features of embodiments, and methods of achieving them will become clear with reference to the detailed description of the following embodiments taken in conjunction with the accompanying drawings. However, embodiments are not limited to the embodiments disclosed below and can be implemented in various forms, these embodiments are provided only to make the disclosure of the present invention complete, and to fully inform those skilled in the art of the scope of the invention to which the present invention belongs, the present invention is only defined by the scope of the claims.

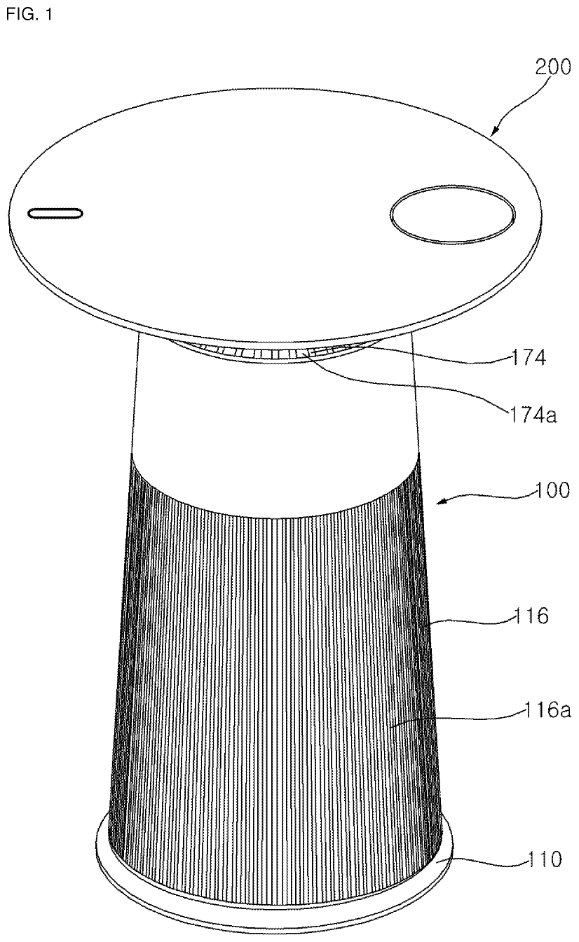

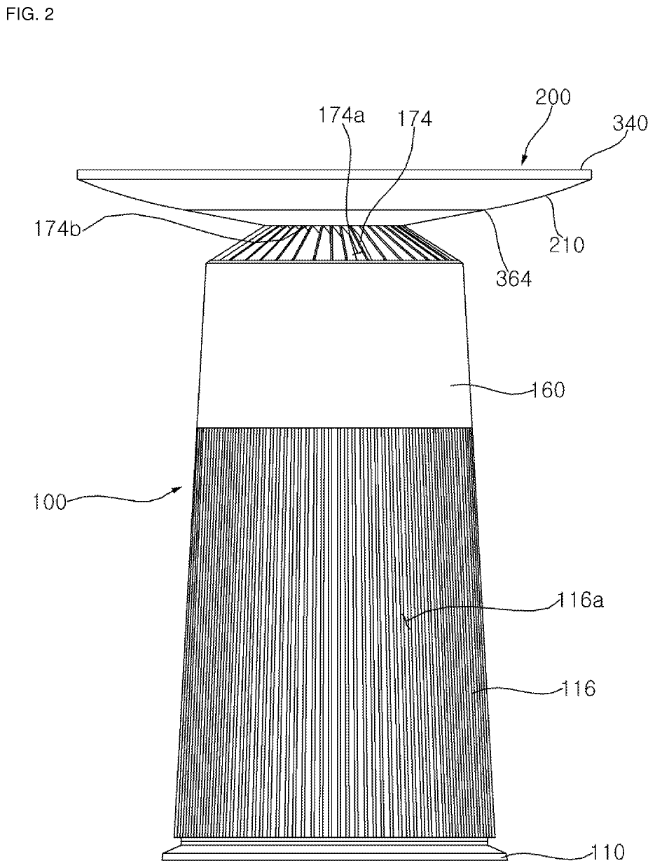

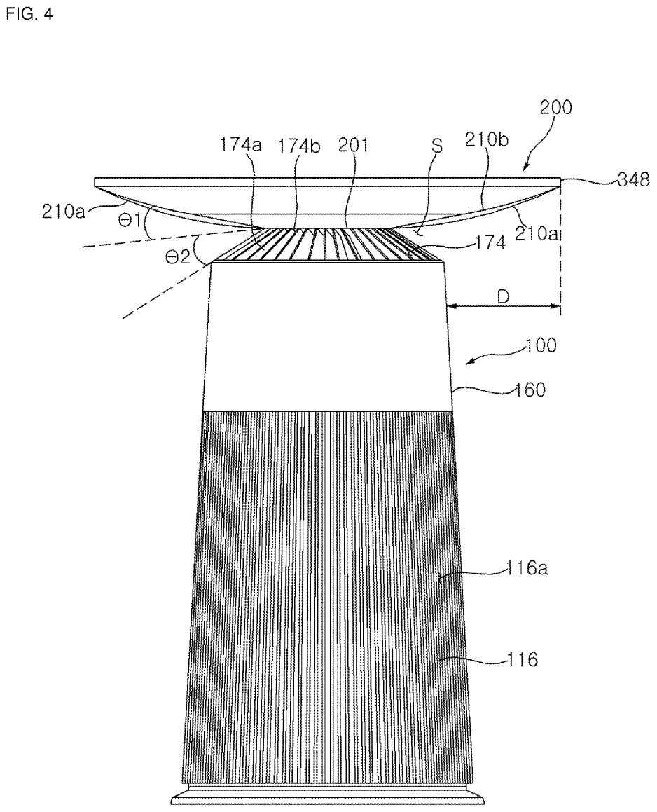

Referring to FIGS. 1 to 5, an air cleaner may include a first body 100 having an inlet 116a at a peripheral surface of the first body 100 and an outlet 174a at an upper surface or upper end of the first body, and a second body 200 disposed above the first body 100 and guiding air discharged from the outlet 174a in a radially outward direction (or outward direction).

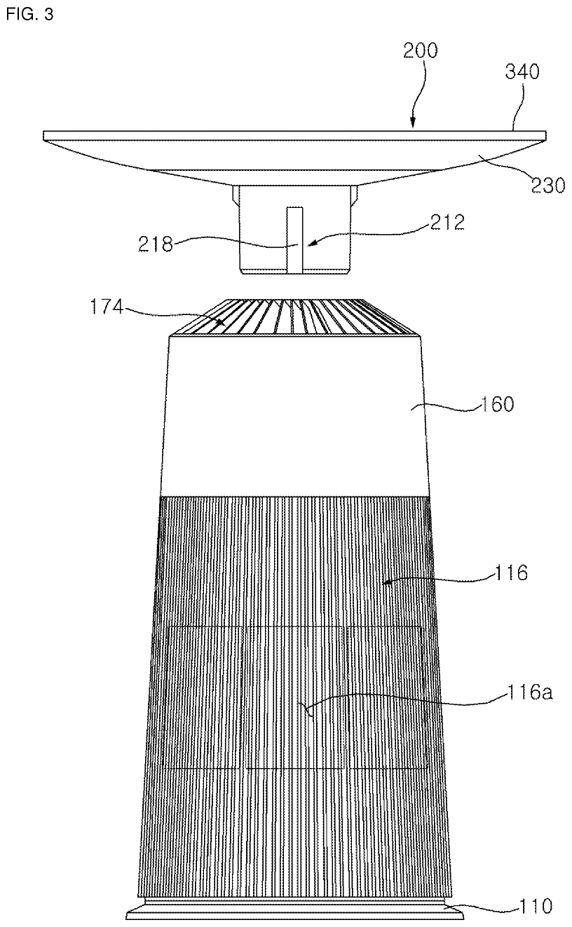

Referring to FIG. 3, aspects of the air cleaner will be described below. The second body 200 may be coupled to the first body 100. The second body 200 may be coupled from above to the first body 100. The second body 200 may include a connecting member connected to the first body 100. A portion of the second body 200 may be inserted into the first body 100. The second body 200 may include an insertion pole (or extension or post) 212 coupled to the first body 100. The insertion pole 212 may extend to a lower side of the second body 200. The insertion pole 212 may be inserted into an upper side of the first body 100. For example, the second body 200 may include the insertion pole 212 extending downward, and the insertion pole 212 may be coupled from above to the first body 100. The upper end has a central portion and an outer portion surrounding the central portion. The central portion includes a recess or a cavity to receive the insertion pole 212. The outer portion is provided with the outlet 174a.

The insertion pole 212 may be extend from the lower cover 210 of the second body 200 toward the first body 100 side. The insertion pole 212 may extend to the lower side of the second body 200. The insertion pole 212 may form an obtuse angle with the guide wall 230 of the lower cover 210. For example, the insertion pole 212 may extend downward, and the guide wall 230 may extend upward toward the lateral direction, so that the insertion pole 212 and the guide wall 230 form an obtuse angle. The insertion pole 212 may be provided at a lower central portion and a lower outer portion surrounding the lower central portion. The insertion pole 212 may be hollow.

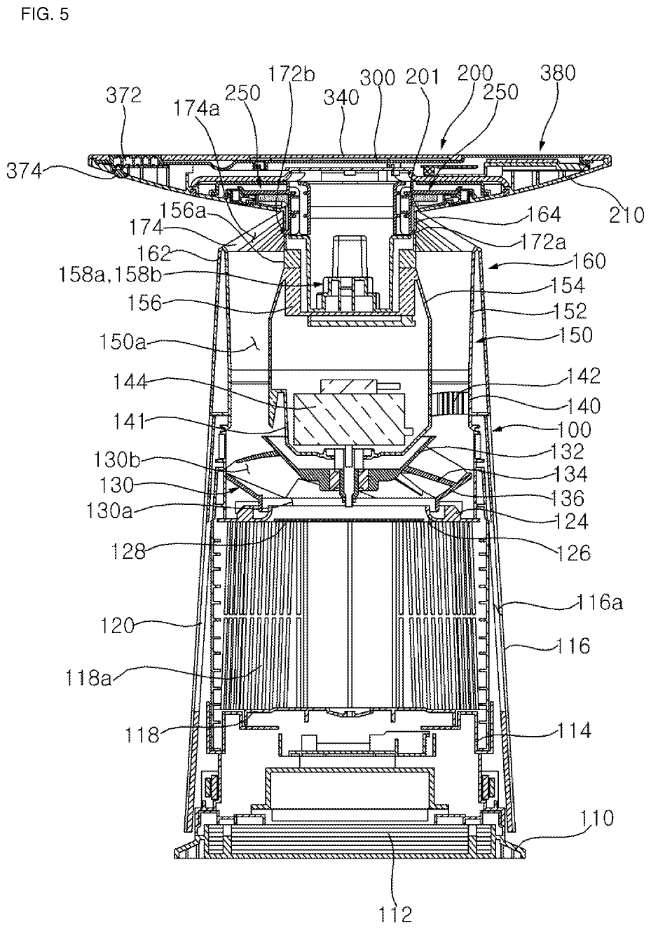

Referring to FIG. 5, the air cleaner may include a base 110 disposed under the first body 100 and contacting the ground. A loading part 112 having an increasing weight may be disposed at a lower portion of the first body 100 to prevent overturn of the air cleaner. The loading part 112 may disposed such that a plurality of plates overlap.

The first body 100 may include a lower housing 114 that is disposed above the base 110 and that forms a space therein accommodating a printed circuit board that controls electronical operation of the air cleaner. The lower housing 114 may be disposed above the base 110. The space in which the printed circuit board is disposed may be formed between the lower housing 114 and the base 110.

The first body 100 may be formed in a cylindrical shape, a cuboid shape, a pyramid shape, or a cube shape. However, the shape of the first body 100 is not limited thereto and may have various shapes. The first body 100 may decrease in width toward the top. For example, the first body 100 may have a cylindrical shape whose width decreases upward.

A filter mount plate 118 may be disposed at an upper surface of the lower housing 114. The filter mount plate 118 may be disposed at a central portion of the lower housing 114. The filter mount plate 118 may disposed at the lower housing 114 to be movable in up-down direction. An elastic member that maintains a position of the elastic member may be disposed between the filter mount plate 118 and the lower housing 114. Therefore, the filter mount plate 118 may protrude upwardly by the elastic member when a filter 118a is not disposed on the filter mount plate 118.

The filter mount plate 118 moves downward when the filter 118a is mounted thereon. The filter mount plate 118 may sense whether the filter 118a is mounted according to a change of disposition in up-down direction.

The air cleaner may include the filter 118a that filters air entering the inlet 116a. The filter 118a may have a cylindrical shape and be disposed inside an inlet grille 116. Therefore, it is possible to filter air flowing upward through the inlet 116a.

The first body 100 may include an inner suction panel 124 spaced upward from the filter mount plate 118 or the lower housing 114, and configured to form an orifice 126, and may include a supporter 120 that connects the lower housing 114 and the inner suction panel 124.

A plurality of supporters or pillars 120 may be disposed along a circumferential direction. The filter may enter through a space between the plurality of supporters 120. The filter mounting plate 118, the lower housing 114 and the supporter 120 may be connected to form a frame serving as an inside skeleton for the first body 100.

The inner suction panel 124 may form a space therebetween in which the filter is disposed by being spaced upward from the filter mount plate 118 or the lower housing 114. The filter may be disposed between the inner suction panel 124 and the lower housing 114. The filter may have a cylindrical shape and may filter foreign substances in air passing through a peripheral surface of the filter. The filter may be disposed between the inner suction panel 124 and the lower housing 114.

The filter 118a may downwardly pressurize the filter mount plate 118 when the filter 118a is disposed between the inner suction panel 124 and the lower housing 114. Since the elastic member upwardly pressurize the filter 118a, a disposition of the filter 118a may be fixed when the filter 118a is disposed between the inner suction panel 124 and the lower housing 114.

The orifice 126, through which air flows to a fan 130 may be formed at a central portion of the inner suction panel 124. The orifice 126 may guide flowing air passing through the filter 118a to the fan 130. A blocking screen 128 (or blocking device) may be disposed at the orifice 126. The blocking screen128 may prevent a body of a user from entering a space in which the fan is disposed.

The inlet grille 116 may be disposed at an outer periphery of the filter 118a. A plurality of inlets 116a may be formed at the inlet grille 116. The inlet grille 116 may be disposed to cover the outer periphery of the filter 118a, and/or an outer periphery of the lower housing 114. The inlet grille 116 may be disposed to cover an outer periphery of the fan housing 140. The inlet 116a formed at the inlet grille 116 may be formed at a peripheral surface of a region that the filter 118a is disposed.

The air cleaner may include the fan 130 rotatably disposed inside the first body 100 and may include a fan motor 144 for rotating the fan 130. The first body 100 may include a fan housing 140 located above the filter 118a and forming a space in which the fan 130 is disposed.

The fan 130 that is disposed above the inner suction panel 124 and that blows air introduced through the orifice 126 in an upward manner, and the fan motor 144 that is disposed above the fan housing 140 and driving the fan 130 may be disposed in the first body 100.

The fan 130 may have a structure of an oblique-flow fan having a fan suction hole 130a that is opened in a downwardly manner, and forming a fan discharging hole 130b that is opened upwardly and outwardly. The fan 130 may include a hub 132 connected to the fan motor 144, a shroud 136 spaced apart from the hub 132 and forming the fan suction hole 130a, and a plurality of blades 134 spaced apart in a circumferential direction. The fan discharging hole 130b may be formed between the hub 132 and the shroud 136. The plurality of blades 134 may induce air flow from the fan suction hole 130a.

The fan housing 140 may disposed above the inner suction panel 124. The fan housing 140 may form a space in which the fan 130 is disposed. The fan housing 140 may form a space that is above the fan 130 and in which the fan motor 144 is disposed. The fan housing 140 may form a flow path guiding air blown by the fan 130 upwardly.

The fan housing 140 may have a cylindrical shape that is opened in up-down direction. A motor cover 141 may be disposed at a central portion of the fan housing 140 in which the fan motor 144 is disposed. The motor cover 141 may have a bowl shape that is depressed downwardly such that the fan motor 144 is disposed.

The fan housing 140 may include a guide vane 142 disposed above the space in which the fan 130 is disposed and for reducing vorticity of air discharged from the fan 130. The guide vane 142 may be disposed to connect an inner circumferential surface of the fan housing 140 and an outer circumferential surface of the motor cover 141. A plurality of guide vanes 142 may be spaced apart in a circumferential direction.

The guide vane 142 may extend in a vertical direction. The air purifier may include multiple guide vanes 142, and the guide vanes 142 may be arranged to spaced apart from each other in a circumferential direction of the first body 100. The guide vanes 142 may be disposed above the fan 130. The guide vane 142 may guide a flow direction of air blown by the fan 130 upward. The guide vane 142 may guide air blown by the fan 130 toward the upward flow path 150a.

The first body 100 may include a discharge guider 150 (or discharge guide) that upwardly guides air flowing upward within the fan housing 140. The discharge guider 150 may be disposed above the fan housing 140 and may form an annular flow path 140a therein.

The discharge guider 150 may include an outer guider or guide 152 that has a cylindrical shape and that extends in an up-down direction, and an inner guider or guide 154 that is disposed radially inward from the outer guider 152 and that extends in an up-down direction.

An upward flow path 150a that has an annular shape may be formed between the outer guider 152 and the inner guider 154. The outer guider 152 may extend from an outer peripheral surface of the fan housing 140. The inner guider 154 may extend upwardly from the motor cover 141.

The outer guider 152 may extend in a vertical direction. The outer guider 152 may be spaced apart from and radially inward from the upper housing 160. The outer guider 152 may extend upward from the inner guider 154. A second upward flow path 150a2 may be defined between the outer guider 152 and the upper housing 160. The outer guider 152 may be inclined relative to a vertical direction. The inner guider 154 may be inclined toward a section of the second body 200, such as the boundary portion 201. The outer guider 152 may be inclined radially inward of the first body 100. The outer guider 152 may be inclined in a direction away from the upper housing 160.

The width of the upward flow path 150a may increase upward.

A connection cover 156 form a recess or cavity in which an insertion pole 212 of the second body 200 is inserted may be disposed at an upper portion of the inner guider 154. In other words, the connection cover 156 is provided at a central portion of the upper end of the first body. The connection cover 156 may form a space for insertion of the insertion pole 212 by being depressed downwardly. Connection terminals 158a, 158b that are coupled to corresponding pole terminals 214a, 214b of the insertion pole 212 may be disposed at a lower portion of the connection cover 156.

The connection terminals 158a, 158b may include a signal terminal that transmits signal(s) and a power terminal that provides power. The connection terminals may include a first connection terminal 158a that provides power and a second connection terminal 158b that transmits signal(s).

The first body 100 may include an upper housing 160 having the upper end that forms the outlet 174a (or outlets) at the outer portion of the upper end through which air flowing upward of the discharge guider 150 is discharged.

The upper housing 160 may be disposed to cover a periphery of the discharge guider 150. The upper housing 160 may have a structure that extends upwardly from the inlet grille 116. The inlet grille 116 may be detachably coupled to the upper housing 160. The outlet 174a may be detachably coupled to the upper housing 160.

The upper housing 160 may include an outer cover 162 that extends upwardly from the inlet grille and an inner cover 164 that is disposed radially inward of the outer cover 162 and that extends upward of the inlet grille 116 and an outlet grille 174 that connects the inner cover 164 and an upper end portion of the outer cover 162.

The outer cover 162 may be disposed to cover a periphery of the discharge guider 150. The outer cover 162 may be disposed to extend upward from the inlet grille 116.

The inner cover 164 may guide such that the insertion pole 212 is inserted into the connection cover 156. The inner cover 164 may has a structure that extends upwardly from the connection cover 156. The inner cover 164 may have a substantially cylindrical shape such that the insertion pole 212 may be disposed inside the inner cover 164.

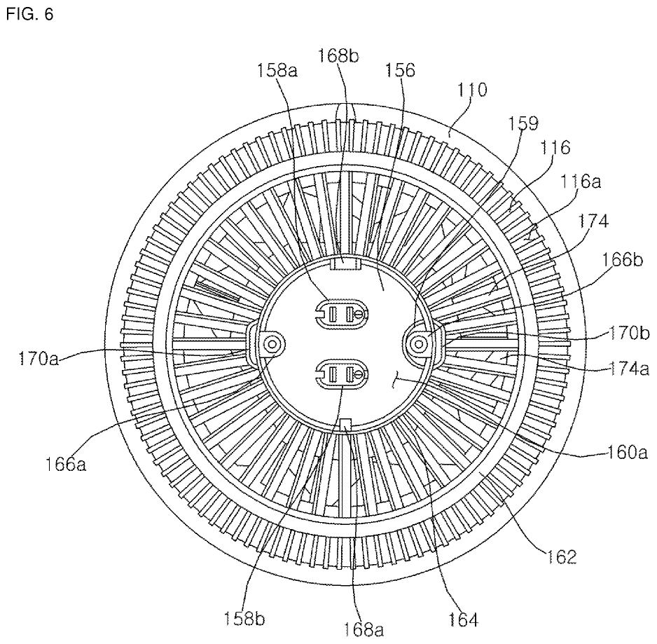

Fastening ribs 166a, 166b that are coupled to the connection cover 156 may be disposed at an inner peripheral surface of the inner cover 164. Referring to FIG. 6, two fastening ribs 166a, 166b, disposed at opposite sides (or in opposite directions to each other), may be disposed at the inner peripheral surface of the inner cover 164. The two fastening ribs 166a, 166b may be disposed to face each other, respectively, and may be of the same size.

Fastening holes or grooves 172a, 172b, in which a hook 252 disposed at the second body 200 is inserted, may be disposed at an inner peripheral surface of the inner cover 164. The fastening holes 172a, 172b may be a pair of fastening holes disposed at opposite sides (or in opposite directions to each other). Each of the pair of fastening holes 172a, 172b may be disposed above each of the two fastening ribs 166a, 166b.

Upper grooves 170a, 170b that guide the hook 252 to the fastening holes 172a, 172b may be disposed at an inner peripheral surface of the inner cover 164. The upper grooves 170a, 170b may disposed above the fastening holes 172a, 172b. The fastening holes 172a, 172b may be spaced downward from an upper end portion of the inner cover 164.

Two guide ribs 168a, 168b, for mounting the second body 200 to a same location, may be disposed at an inner peripheral surface of the inner cover 164. The two guide ribs 168a, 168b may be disposed at opposite sides (or in opposite direction to each other). Sizes of the two guide ribs 168a, 168b may be different.

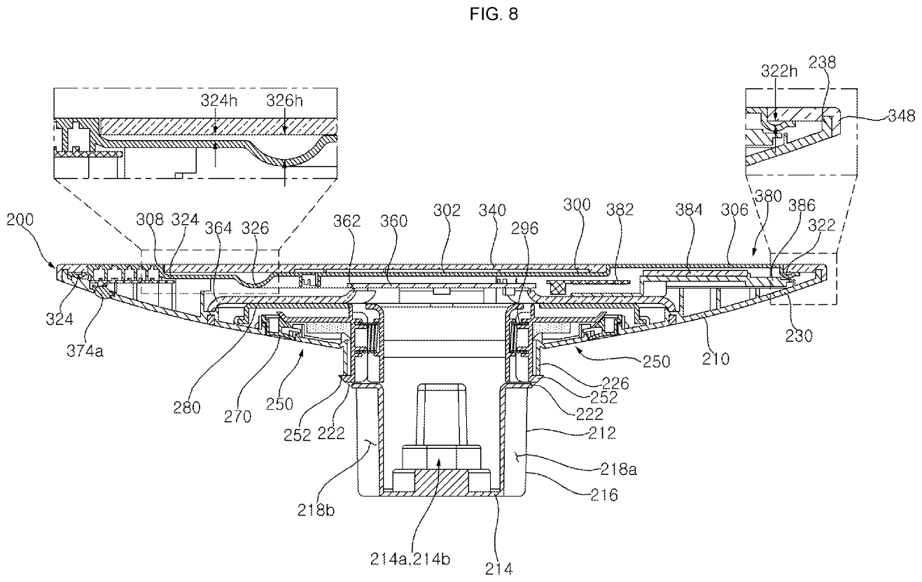

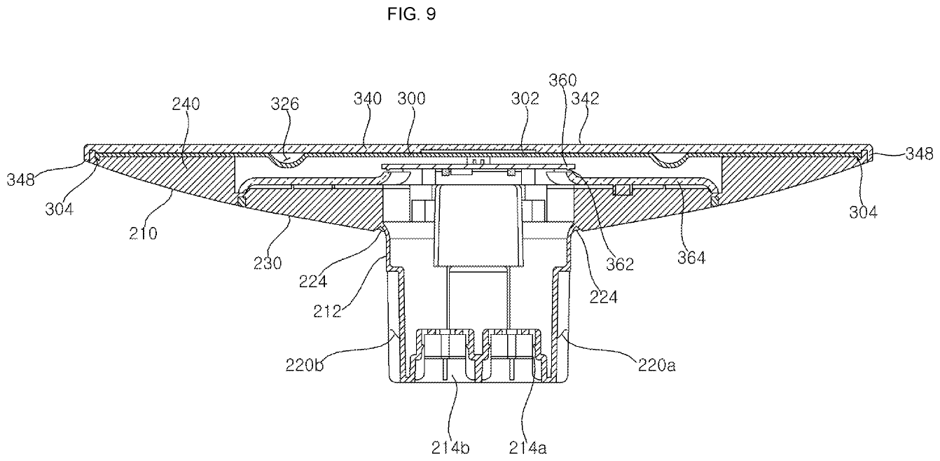

As shown FIG. 6, the coupling groove 160a is a groove for inserting the insertion pole 212, and the two fastening ribs 166a, 166b and the two guide ribs 168a, 168b are disposed to intersect each other. As shown FIG. 8, each of the two fastening rib grooves 218a, 218b are guided by the each of the two fastening ribs 166a, 166b, and as shown FIG. 9, each of the guide grooves 220a, 220b are guided by the each of the two guide ribs 168a, 168b. The fastening holes 172a, 172b are corresponding to the hook 252. The hook 252 is disposed above the two fastening rib grooves 218a, 218b. Therefore, each of the fastening holes 172a, 172b are disposed above each of the two fastening ribs 166a, 166b. As shown in FIG. 6, the upper grooves 170a, 170b are configured to guide the hook 252 to the fastening holes 172a, 172b.

The outlet grille 174 may have a structure that extends from an upper end of the inner cover 164 toward the outer cover 162. Referring to FIG. 5, the upper end of the inner cover 164 may be higher than an upper end of the outer cover 162. The upper housing 160 may include a plurality of outlet grilles 174 (or outlets) that are spaced apart in a circumferential direction at an upper portion of the inner cover 164.

Each of the plurality of outlet grilles 174 may have a shape in which an inclination angle at an inner end thereof is different than an inclination angle at an outer end thereof. In this example, the inner end of the outlet grille 174 may be a contacting portion of the outlet grille 174 and the inner cover 164. The outer end of the outlet grille 174 may be a contacting portion of the outlet grille 174 and the outer cover 162. In this example, an inclination angle may mean an intersection angle of a line or a plane parallel to the ground and a plane formed by the outlet grille 174. The outlet grille 174 may reduce vorticity of air discharged from the fan 130.

The first body 100 may include a coupling groove 160a depressed downward and located inward of the annular outlet 174a. The coupling groove 160a may be formed at an inside of the inner cover 164 that is formed at the upper housing 160. The coupling groove 160a may be formed inside of the inner guider 154 (of the discharge guider 150). The connection terminal 158a, 158b coupled to the connection cover 156 may be disposed at the coupling groove 160a.

The coupling groove 160a (a recess, cavity or an opening) may be a region in which the insertion pole 212 (of the second body 200) is inserted and may span to the upper housing 160.

Therefore, a structure formed on an inner surface of the inner cover 164 and a structure formed on an inner circumferential surface of the inner guider 154 may be included at the coupling groove 160a.

The second body 200 may include a boundary portion (or boundary region) 201. The boundary portion 201 may be located above the outlet 174a. The boundary portion 201 may extend in a circumferential direction corresponding to a direction in which the outlet grille 174 extends. The boundary portion 201 may refer to an area where the outlet 174a and the second body 200 are in contact.

The second body 200 may include a lower surface 210b. The lower surface 210b may be spaced apart upward from the outlet 174a. The lower surface 210b may extend horizontally or obliquely upward from the boundary portion 201. The lower surface 210b may be defined in an annular shape along a direction that the outlet grille 174 extends. A discharge space S may be defined between the outlet grille 174 and the lower surface 210b. The lower surface 210b may face the outlet grille 174 in the vertical direction, and the discharge space S may refer to a space defined between the lower surface 210b and the outlet grille 174.

The outlet 174a may include an outlet top 174b. The outlet top 174b may be spaced apart upward from the upper housing 160. The outlet top 174b may extend circumferentially along a direction in which the outlet grille 174 extends. The outlet top 174b may be in contact with the boundary portion 201. The outlet top 174b may correspond to the boundary portion 201 in the vertical direction. A sealing member (or seal) may be disposed between the outlet top 174b and the boundary portion 201.

The lower surface 210b may be inclined upward toward outside of the air purifier in a radial direction. The lower surface 210b may be inclined in a direction away from the outlet grille 174. The lower surface 210b may be upward inclined at an inclination angle θ1 with respect to a horizontal direction.

The outlet 174a may be inclined upward toward an inside of the air purifier a radial direction. The outlet 174a may be inclined upward toward central portion of the first body 100. The outlet 174a may be inclined downward at an inclination angle θ2 with respect to the horizontal direction.

The lower surface 210b and the outlet 174a may be inclined in an opposite direction. The lower surface 210b may be inclined toward an outer side of the air purifier in the radial direction, and the outlet 174a may be inclined toward an inner side of the air purifier in the radial direction. An inclination angle θ1+θ2 may be defined between the lower surface 210b and the outlet 174a. The inclination angles θ1 and/or θ2 may be acute angles and the angle θ1 increases in the radial direction. Hence, angle θ1+θ2 increases in the radial direction.

The boundary wall 348 may be located further out in a radial direction of the air purifier than the upper housing 160 of the first body 100. The boundary wall 348 may be located further out in a radial direction of the air purifier than the outlet grille 174. A distance D may be defined between outer circumferential surface (e.g., upper housing 160) of the first body 100 and boundary wall 348. The outlet grille 174 and the boundary wall 348 may be spaced apart by predetermined distance D in the radial direction of the first body 100.

The air purifier may include a guide rib 210a. The guide rib 210a may be positioned on the lower surface 210b of the second body 200. Discharged air through the outlet grille 174 may flow to the boundary wall 348 along the guide rib 210a.

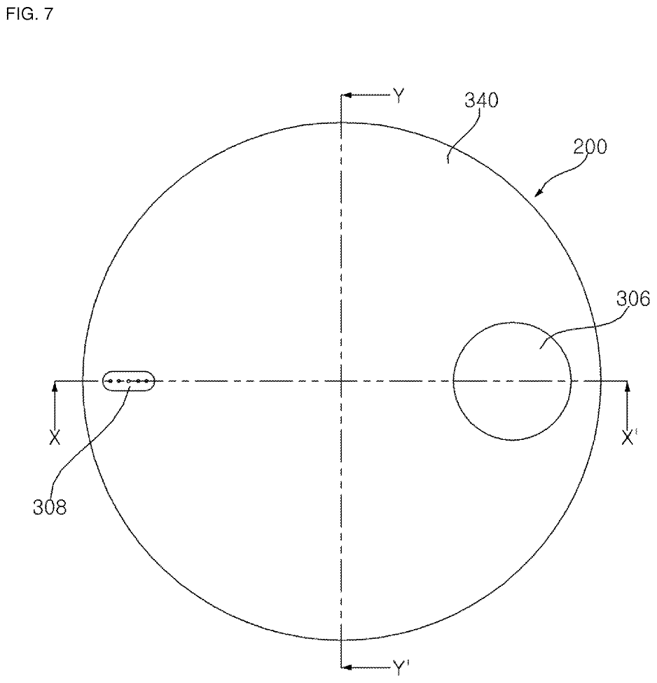

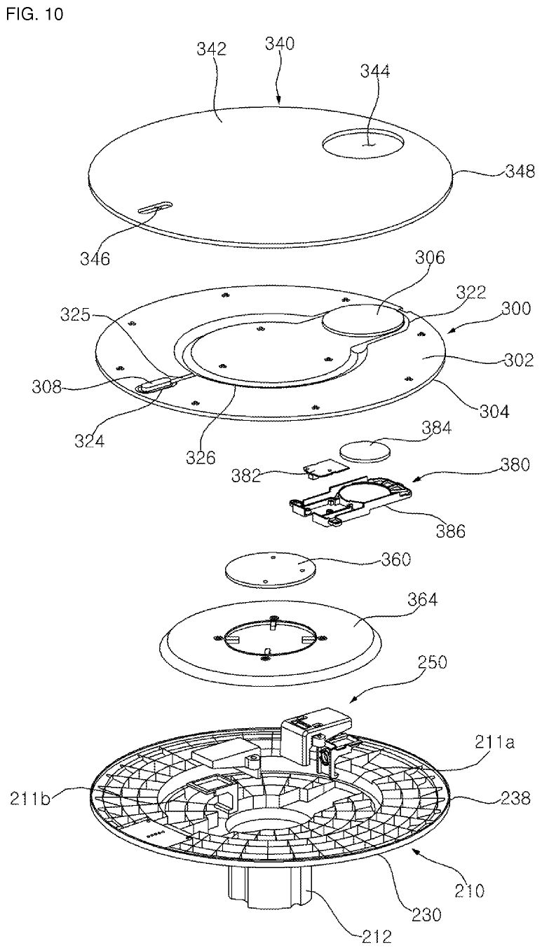

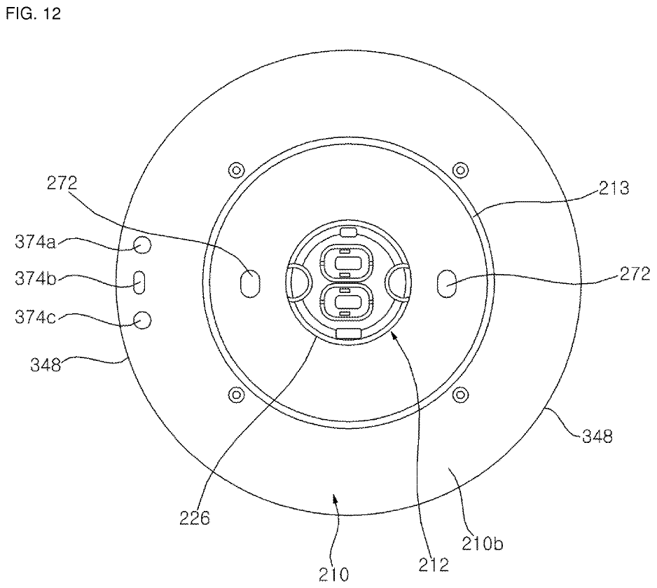

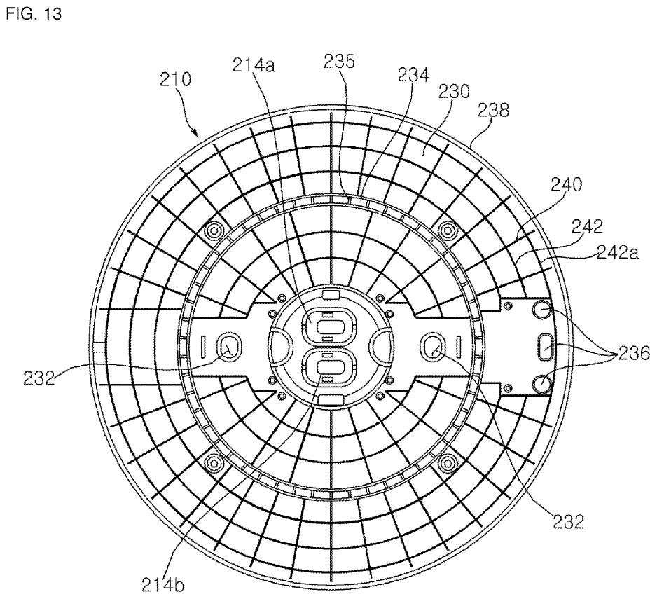

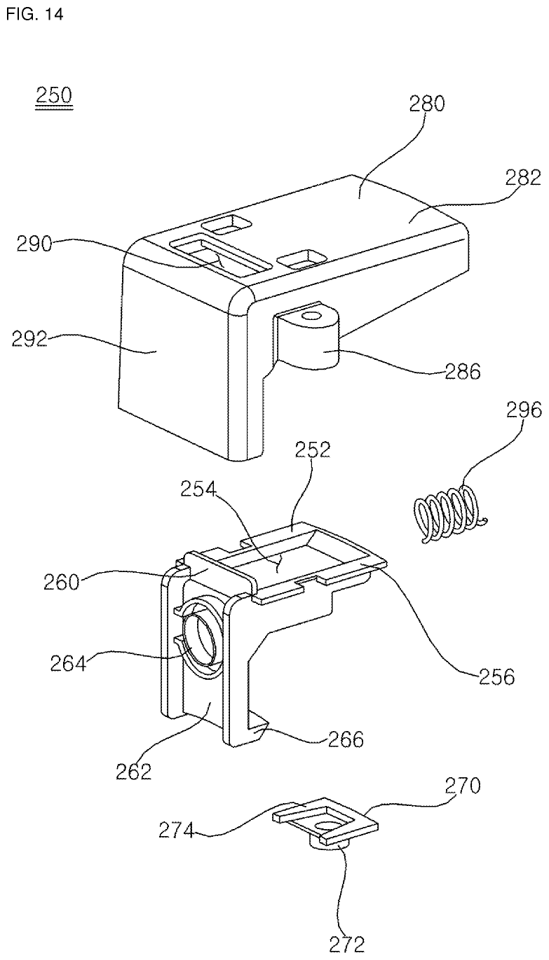

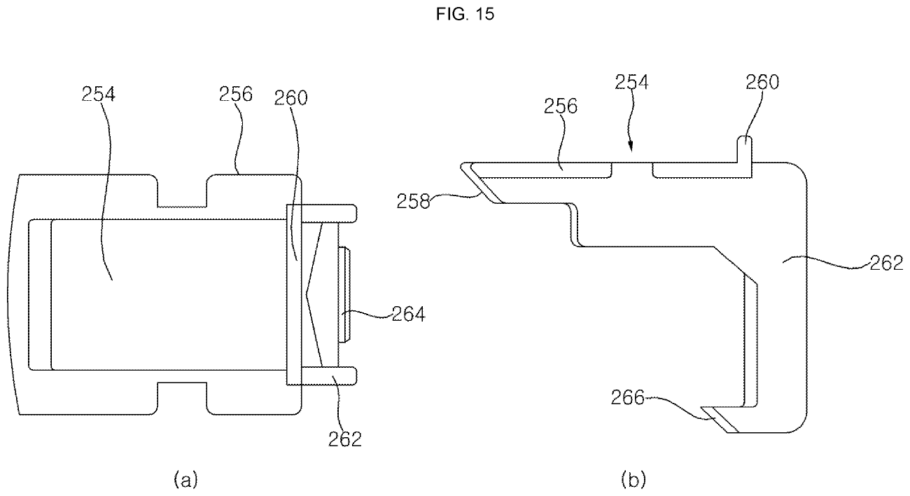

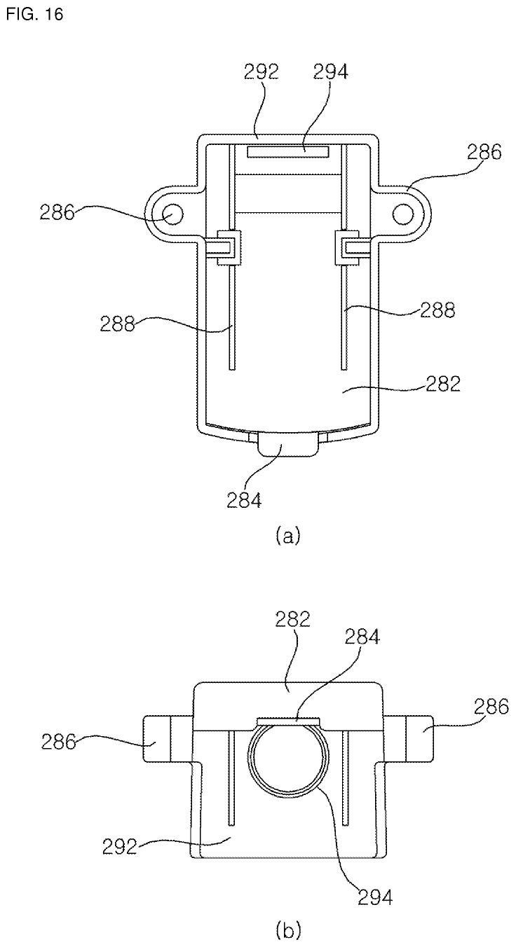

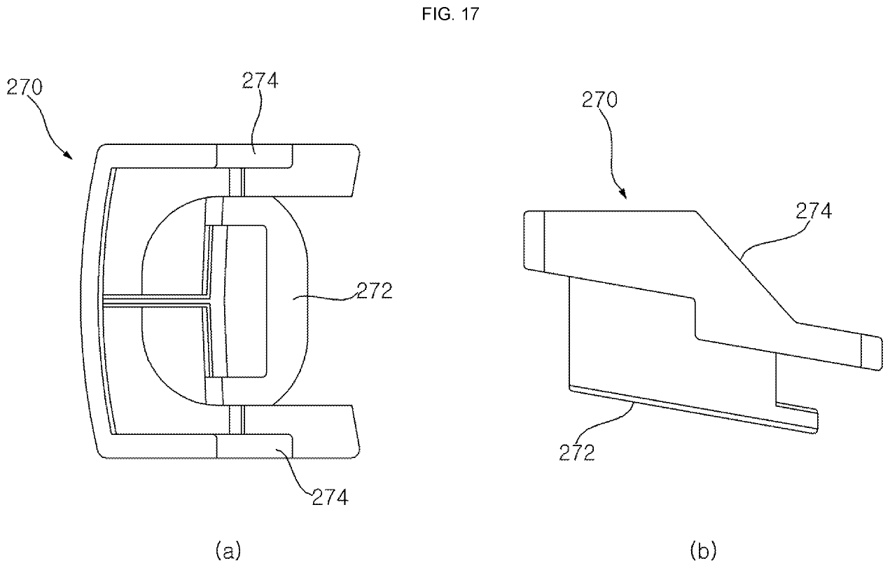

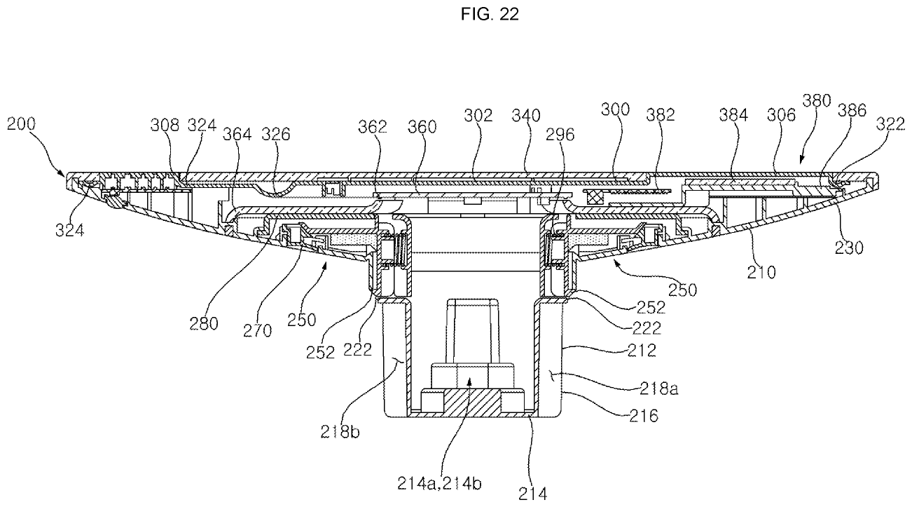

FIGS. 7 to 22 relate to the second body 200 of the air cleaner according to one embodiment.

A lower surface of the second body 200 may guide air flowing upward through the outlet 174a (or outlet grille 174) in a radially outward direction (or outward directions). An upper surface of the second body 200, that includes at least a flat plane, may be used as a table. An area formed by the upper surface of the second body 200 may be larger than an area formed by the outlet 174a. When viewed from the top, the outlet 174a formed at the first body 100 may have a structure hidden by the upper surface of the second body 200. Therefore, liquid or stuff on the upper surface of the second body 200 may be prevented from falling and entering into the outlet 174a (or the outlet grille).

The second body 200 may include a lower cover 210 that guides air discharged from the outlet 174a (of the first body 100) in a radially outward direction, an upper cover 300 disposed on the lower cover 210, and a top cover 340 disposed on the upper cover 300.

The second body 200 may further include a coupling portion 250 (or coupler) fixing the second body 200 to an upper side of the first body 100. The coupling portion 250 may have a structure that protrudes outward from a peripheral surface of the insertion pole 212 to attach the second body 200 when the insertion pole 212 (of the second body 200) is disposed in the coupling groove 160a (of the first body 100).

The upper surface of the second body 200 may be formed of abrasion-resistant PC material. Therefore, the upper surface of the second body 200 may be formed of a material that does not abrade by stuff thereon. The upper surface of the second body 200 may be formed of heat-resistant PC material. It is possible to minimize deformation thereof even if a hot object is placed on the upper surface of the second body 200.

The lower cover 210 may attach to the first body 100, and may guide air discharged from the outlet 174a of the first body 100 in a radially outward direction (or outward directions). The lower cover 210 may have a bowl shape in which electronic units are disposed. The electronic unit may mean a device which is electrically operable. In this embodiment, the electronic unit may include a charging unit 380 (or charger), a first lamp 362 and a second lamp 372.

The lower cover 210 may include the insertion pole 212 which is inserted into the connection cover 156 of the first body 100, and a guide wall 230 that is disposed above the outlet grille 174 and in which a diameter thereof expand as it goes upwardly.

The lower cover 210 may include a step portion (or step surface) 211a. The step portion 211a may be bent downward from the guide wall 230. The step portion 211a may be bent toward the insertion pole 212.

The lower cover 210 may include an accommodation space 211b. The accommodation space 211b may be defined inside the guide wall 230. The accommodation space 211b may be defined above the insertion pole 212. The accommodation space 211b may be defined radially insider the step portion 211a.

The insertion pole 212 may include a peripheral wall 216 that is inserted into the connection cover 156, and a lower wall 214 disposed at a lower end of the peripheral wall 216. The insertion pole 212 may have a substantially cylindrical shape. The insertion pole 212 may extend in a vertical direction. The insertion pole 212 may be coupled to the connection cover 156. A diameter of the insertion pole 212 may be smaller than a diameter of the upper housing 160. The insertion pole 212 may be inserted toward inside the first body 100 and coupled to the first body 100. The insertion pole 212 may be coupled to a section of the first body 100, such as connection cover 156.

The second body 200 may include a lamp (or lighted region) 213. The lamp 213 may receive light from the light source guide 364. The lamp 213 may be exposed on lower side of the lower surface 210b. The lamp 213 may radiate light transmitted from the light source guide 364 to the lower side of the lower surface 210b. The lamp 213 may have an annular shape. The lamp 213 may be located outside of the insertion pole 212 in the radial direction. The lamp 213 may be located outside of the press plate 272 in the radial direction, and a distance between the lamp 213 and the insertion pole 212 may be greater than a distance between the press plate 272 and the insertion pole 212.

The corresponding pole terminals 214a, 214b corresponding to the connection terminals 158a, 158b may be disposed at the lower wall 214. The corresponding pole terminals 214a, 214b may include a terminal for receiving power and a terminal for receiving signal(s).

Each of two corresponding pole terminals 214a, 214b may be connected to each of two connection terminals 158a, 158b. The two corresponding terminals may include a first pole terminal 214a connected to the first connection terminal 158a and a second pole terminal 214b connected to the second connection terminal 158b. The first connection terminal 158a may be connected to the first pole terminal 214a, and the second connection terminal 158b may be connected to the second pole terminal 214b.

The corresponding pole terminal(s) 214a, 214b may be connected to the connection terminal(s) 158a, 158b when the second body 200 is mounted on the first body 100.

Fastening rib groove(s) 218a, 218b, in which the fastening rib is inserted, may be formed at the peripheral wall 216 when the second body 200 is mounted on the first body 100. The two fastening rib grooves 218a, 218b may be formed at the peripheral wall 216. The two fastening rib grooves 218a, 218b may be disposed in opposite directions to each other (i.e., at opposite sides).

Guide grooves 220a, 220b, in which one of the guide ribs 168a, 168b is inserted, may be formed at the peripheral wall 216, when the second body 200 is mounted on the first body 100. The two guide grooves 220a, 220b having different sizes may be formed at the peripheral wall 216. Each of the two guide grooves 220a, 220b may have a shape corresponding to each of two guide ribs 168a, 168b having different sizes and may be disposed a location corresponding to each of the two guide ribs 168a, 168b.

Since each of the two guide ribs 168a, 168b having different sizes is inserted into corresponding two guide grooves 220a, 220b, the coupling position between the first body 100 and the second body 200 may be unchanged. Therefore, the first connection terminal 158a and the second connection terminal 158b may be connected to the first pole terminal 214a and the second pole terminal 214b, respectively.

A hook hole(s) 222, in which the hook 270 of the coupling portion 250 penetrates, may be disposed at the peripheral wall 216. The hook hole(s) 222 may be disposed above each of the coupling rib groove(s) 218a, 218b.

An edge groove 224 of an upper end portion of the inner cover 164 of the upper housing 160 may be formed at an upper end portion of the insertion pole 212. The edge groove 224 may form a groove, facing the guide wall 230, at the upper end portion of the insertion pole 212.

The guide wall 230 may be disposed above the outlet 174a, and may have a shape that extends upward of the outlet 174a. The guide wall 230 may have a shape in which a diameter thereof expands as it goes upwardly.

Referring to FIG. 8, the guide wall 230 may have a shape in which an inclination angle thereof increases as it goes upward from a lower end portion thereof. In this example, the inclination angle may mean an intersection angle between a plane parallel to the ground and the guide wall 230.

A lower end portion of the guide wall 230 may extend from an upper end portion of the inner cover 164. An upper end portion of the guide wall 230 may be larger than a diameter of an peripheral surface formed by the outer cover 162.

A hook button hole 232, in which the hook 270 of the coupling portion 250 is disposed, may be formed at the guide wall 230. A lighting hole 234, through which a part of a light source guide 364 is exposed, may be formed at the guide wall 230. The lighting hole 234 may be formed in a ring shape. The lighting hole 234 may be divided into a plurality of portions by a supporting rib 235 that supports the light source guide 364.

A main button hole 236, in which a button 374 is disposed, may be formed at the guide wall 230. The main button hole 236 may be formed in a number corresponding to a number of buttons 374 disposed thereon. The main button hole 236 may have a shape corresponding to a shape of the button 374.

The lower cover 210 may include a plurality of ribs that protrude upwardly from an upper surface of the guide wall 230.

The lower cover 210 may include an edge rib 238 that protrudes upwardly from an upper end of the guide wall 230. Referring to FIG. 6, the edge rib 238 may be disposed inside of a boundary wall 348 of the top cover 340. The edge rib 238 may be disposed outward of an outer periphery of a plate edge 304 of the upper cover 300.

The lower cover 210 may include a plurality of partition ribs 240, 242 that extend upward from an upper surface thereof and that divide a space above the lower cover 210. The plurality of partition ribs 240, 242 may have a concentric circle structure having different radii. The plurality of partition ribs 240, 242 may have structure that extends radially.

The plurality of partition ribs 240, 242 may include a first partition rib 242a that is disposed to face the edge rib 238.

The plurality of partition ribs 240, 242 may include a plurality of radial ribs 240 that extend from a lower end portion of an upper surface of the guide wall 230 in a radially outward direction and a plurality of circumferential ribs 242 that have different radii and are disposed at an upper surface of the guide wall 230 and formed to have a ring shape. The plurality of circumferential ribs 242 may have the same center. The plurality of circumferential ribs 242 may have a same concentric center of the edge rib 238.

The plurality of circumferential ribs 242 may have different radii and may divide a space above the lower cover 210 by protruding upwardly from the guide wall 230. Therefore, even if water from the upper cover 300 enters thereinto, the water may be prevented from entering inside of the lower cover 210.

The plurality of circumferential ribs 242 may include a first circumferential rib 242a adjacent to the edge rib 238. The first circumferential rib 242a may be disposed to face the edge rib 238.

The coupling portion 250 (or coupler) may couple the second body 200 to the first body 100, or may decouple the second body 200 from the first body 100.

The coupling portion 250 may include a hook 252 movably disposed inside the lower cover 210, and the hook button 270 that changes disposition of the hook 252.

The coupling portion 250 may include a hook guider 280 disposed inside the lower cover 210 for guiding the hook 252, and an elastic member 296 disposed between the hook guider 280 and the hook 252.

The hook 252 may include a first moving body 254 that contacts the hook button 270 and that moves in conjunction with movement of the hook button 270, a second moving body 262 that is bent downward from one side of the first moving body 254, and an insertion protrusion 266 that is bent from an end portion of the second moving body 262 and is disposed to protrude outwardly.

The first moving body 254 may form an upper wall of the hook 252 by contacting the hook button 270. The first moving body 254 may do a linear reciprocating motion in a radial direction along a space formed by the hook guider 280.

In this example, the radial direction in which the first moving body 254 moves may be set with respect to a center of the circle shown when viewed from the top.

The first moving body 254 may move in the radial direction inside the lower cover 210 by contacting with the hook button 270. The first moving body 254 may include a button contacting portion 258 that contacts with the hook button 270. The button contacting portion 258 may form an inclined surface to move in the radial direction when the hook button 270 moves in the up-down direction.

The first moving body 254 may extend in a direction perpendicular to a direction of movement of the first moving body 254 and may include a guide protrusion 256 that is disposed above an inner protrusion 288 of the hook guider 280.

The first moving body 254 may protrude upwardly and may be disposed at a moving guide groove 290 of the hook guider 280 and may include an upper protrusion 260 that restricts a movement range of the first moving body 254.

The lower surface of the hook button 270 may form a continuous surface to the guide wall 230. That is, it is possible to maintain streamline of air flowing along the guide wall 230.

The hook button 270 may include a press plate 272 disposed to be exposed to the hook button hole 232 (of the lower cover 210) and a hook contacting portion 274 disposed above the press plate 272 and contacting the button contacting portion 258. The hook contacting portion 274 may form an inclined surface and may be disposed to contact with the button contacting portion 258.

The hook guider 280 may be fixed to an inside of the lower cover 210. The hook guider 280 may guide a radial reciprocation movement of the hook 252. The hook guider 280 may include an upper wall 282 that guides movement of the hook 252 and an end wall 292 that extends downward from an end portion of the upper wall 282.

A fixing protrusion 284 that protrudes in an opposite direction to the end wall 292 may be disposed at the upper wall 282. Since the fixing protrusion 284 protrudes from the upper wall 282, the fixing protrusion 284 may fix the hook guider 280.

A coupling protrusion 286 spaced apart from the fixing protrusion 284 and that couples the hook guider 280 to the lower cover 210 may be disposed at the upper wall 282. The coupling protrusion 286 may be coupled to the lower cover 210 by a fastener.

The moving guide groove in which the upper protrusion 260 of the hook 252 is disposed and that restricts a movement range of the hook 252 may be formed at the upper wall 282.

The inner protrusion 288 protruding downward and restricting upward movement of the hook 252 may be disposed at a lower surface of the upper wall 282. The inner protrusion 288 may be disposed to extend along a movement direction of the hook 252.

The end wall 292 may be perpendicular to the upper wall 282. The elastic member 296 that maintains a disposition of the hook 252 may be disposed between the end wall 292 and the hook 252. A first elastic member fixing portion 264 that fixes one end of the elastic member 296 may be disposed at the second moving body 262. A second elastic member fixing portion 294 that fixes the other end of the elastic member 296 may be disposed at the end wall 292.

As shown in FIG. 8, the elastic member 296 may push the hook 252 radially outward when the user does not apply force to the hook button 270. The hook button 270 may be disposed to be exposed through the hook button hole 232 when the user does not apply force to the hook button 270.

The insertion protrusion 266 of the hook 252 may protrude outward by passing through the hook button hole 232 of the lower cover 210 when the user does not apply force to the hook button 270.

A plurality of first lamps 362, a first board 360 that operates the plurality of first lamps 362, and the light source guide 364 that guides light emitted from the first lamp 362 to a lower side of the lower cover 210 may be disposed above the lower cover 210.

One end portion of the light source guide 364 may be disposed below the first lamp 362. The other end portion of the light source guide 364 may be disposed at the lighting hole 234 formed on the guide wall 230.

A plurality of second lamps 372 that display operation state of the air cleaner and a second board 370 that operates the plurality of second lamps 372 may be disposed above the lower cover 210.

The second board may a substantially rectangular plate shape. The plurality of second lamps 372 may be disposed at an upper surface of the second board 370. The plurality of second lamps may be disposed at the upper surface of the second board 370 to be spaced apart in a circumferential direction.

The button 374 that controls operation or power of the air cleaner may be disposed below the second board 370. The button 374 may be disposed at the main button hole 236 of the lower cover 210. The button 374 may include a plurality of button portions. The plurality of button portions included in the button 374 may have different sizes. The plurality of button portions included in the button 374 may protrude in different directions with respect to the lower cover 210. The button 374 may be electrically connected to the fan 130. A user can manipulate the button 374 to adjust driving or operation state of the fan 130. The button 374 may have a first button 374a, a second button 374b and/or a third button 374c. The first to third buttons 374a, 374b, 374c may be exposed on lower side of the lower surface 210b. The first to third buttons 374a, 374b, 374c may each have a different shape from one another. At least one of the first to third buttons 374a, 374b, 374c may protrude downward from the lower surface 210b. In another example, at least one of the first to third buttons 374a, 374b, 374c may be recessed upward toward upper side of the lower surface 210b. A user may manipulate the first to third buttons exposed on lower side of the lower surface 210b to adjust operation of the air purifier, including the fan 130. The buttons 374a, 374b, 374c may be located outside of the insertion pole 212 in the radial direction. A distance between the buttons 374a, 374b, 374c and the insertion pole 212 may be greater than a distance between the buttons 374a, 374b, 374c and the press plate 272. A distance between the buttons 374a, 374b, 374c and the boundary wall 348 may be smaller than a distance between the buttons 374a, 374b, 374c and the insertion pole 212. The first button 374a may induce the Coanda effect in air flowing along the lower surface 210b, and air flowing outward along the lower surface 210b may be guided toward the boundary wall 348 by the first button 374a. In particular, after air discharged through the outlet grille 174 flows upward along the outer circumferential surface 226, the air may be guided by the lower surface 210b. Air flowing along the lower surface 210b may be guided toward the boundary wall 348 by the press plate 272 and the buttons 374a, 374b, 374c.

The charging unit 380 (or charging device or charger) may be disposed above the lower cover 210. The charging unit 380 may charge an electronic device disposed above the upper cover 300 or the top cover 340.

The charging unit 380 may supply power, using magnetic induction or magnetic resonance method, to the electronic device (or electronic unit) disposed above the upper cover 300 or the top cover 340.

The charging unit 380 may include a charging pad 384 that supplies power to electronic device adjacent thereto, a third board 382 that controls operation of the charging pad 384, an inner plate 386 that attaches the charging pad 384 and the third board 382.

The inner plate 386 may be disposed above the light source guide 364. The inner plate 386 may be fixed to the light source guide 364 or the lower cover 210.

A board fixing portion 390 in which the third board 382 is fixed, and a pad fixing portion 392 may be disposed at the inner plate 386. The pad fixing portion 392 may form a groove into which the charging pad 384 is inserted.

The upper cover 300 may be disposed to cover an upper part of the lower cover 210. The upper cover may cover electronic units (or electronic devices) disposed inside the lower cover 210.

The upper cover 300 may have a substantially disc shape. The upper cover 300 may have a shape corresponding to an upper surface of the lower cover 210.

The upper cover 300 may include a plate 302, and at least one protruding cover 306, 308 protruding upwardly from the plate 302. The upper cover 300 may include a plurality of protruding covers 306, 308 disposed at the plate 302 and spaced apart to each other.

The upper cover 300 may include the plate 302 that has a disc shape, a plate edge 304 that is bent downward from an outer periphery of the plate 302, a first protruding cover 306 that is spaced upward from the plate 302 and that covers an upper side of the charging pad 384 of the charging unit 380, a second protruding cover 308 that covers an upper side of the second lamp 372. A groove(s) 322, 324 depressed downward from a periphery of the protruding cover(s) 306, 308 may be formed at the plate 302.

The plate 302 may have a substantially disc shape. The plate 302 may be disposed to cover an upper side of the lower cover 210. A diameter of the plate 302 may be smaller than a diameter of an upper end portion of the lower cover 210. The plate edge 304 may have a structure that is bent downward from an outer periphery of the plate 302. The diameter of the plate 302 may be larger than a diameter formed by the first circumferential rib 242a. Therefore, fluid flowing downward from the plate 302 may flow outside the first circumferential rib 242a.

The first groove 322 is depressed downward from an outer periphery of the first protruding cover 306, and the second groove 324 is depressed downward from an outer periphery of the second protruding cover 308.

A connection groove 326 that is disposed between the second protruding cover 308 and the first protruding cover 306 and which is depressed downward may be formed at the plate 302. The connection groove 326 which is connected to the plurality of grooves 322, 324 and which is depressed downward may be formed at the plate 302. The connection groove 326 may be formed inside the plurality of grooves 322, 324 in a ring shape.

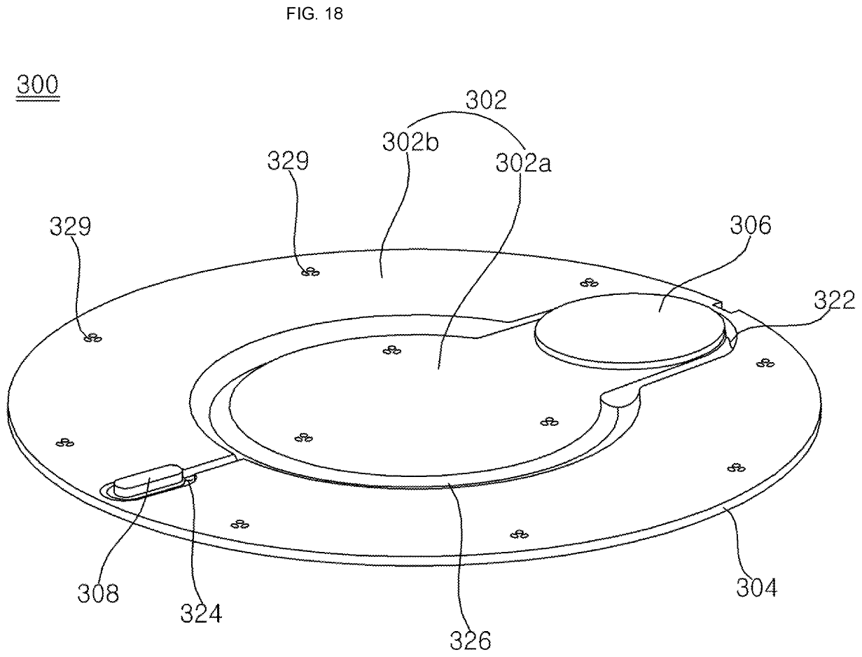

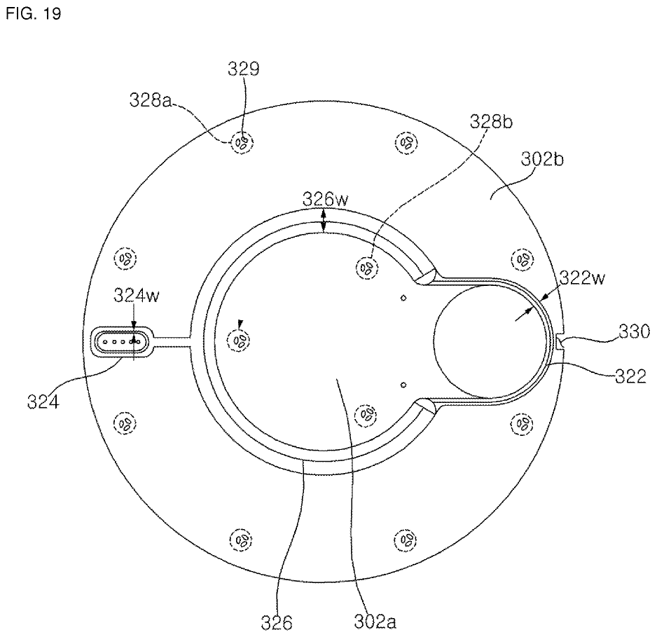

Referring to FIGS. 18 to 19, each of the first groove 322 and the second groove 324 may be connected to the connection groove 326. Referring to FIG. 8, a depth 322h, 324h of the first groove 322 and the second groove 324 may be smaller than a depth of the connection groove 326. Referring to FIG. 19, widths 322w, 324w of each of the first groove 322 and the second groove 324 may be smaller than a width 326w of the connection groove 326. Referring to FIG. 19, a length of the first groove 322 that extends along a periphery of the first protruding cover 306 and a length of the second groove 324 that extends along a periphery of the second protruding cover 308 may be shorter than a length of ring shape between the first groove 322 and the second groove 324 of the connection groove 326.

The plate 320 may include a first plate 302a disposed radially inside of the connection groove 326, and a second plate 302b disposed radially outside of the connection groove 326.

The first protruding cover 306 and the second protruding cover 308 may be spaced upward from the plate 302. The first protruding cover 306 may be disposed at a first hole 344 of the top cover 340, and the second protruding cover 308 may be disposed at a second hole 346 of the top cover 340.

An upper surface of the first protruding cover 306 may have a different shape from an upper surface of the second protruding cover 308. The upper surface of the first protruding cover 306 may have a different size from the upper surface of the second protruding cover 308.

The top cover 340 may be disposed to cover at least portion of the upper cover 300. The top cover 340 may be disposed above the upper cover 300. Referring to FIGS. 8 to 9, a diameter of the top cover 340 may be larger than a diameter of an upper end portion of the lower cover 210. That is, an outer periphery wall of the top cover 340 may have a structure that surrounds an upper end portion of the lower cover 210. Therefore, it is possible to prevent fluid flowing outward from the top cover 340 from entering into the lower cover 210.

The top cover 340 may be formed of abrasion-resistant PC material. The top cover 340 may be formed of heat-resistant PC material. A hole(s) corresponding to the protruding cover(s) 306, 308 of the upper cover 300 may be formed at the top cover 340. A plurality of holes 344, 346 may be formed at the top cover 340, and each of the plurality of holes 344, 346 may be located at positions corresponding to the protruding cover(s) 306, 308.

The top cover 340 may include a cover plate 342 and the boundary wall 348 that extends downwardly from an outer periphery of the cover plate 342.

An upper surface of the cover plate 342 may be flat. Since the upper surface of the cover plate 342 is flat, the user can put stuff on the top cover 340.

The first hole 344 in which the first protruding cover 306 is disposed and the second hole 346 in which the second protruding cover 308 is disposed may be formed at the cover plate 342. The first hole 344 may be shaped to correspond to the first protruding cover 306. The second hole 346 may be shaped to correspond to the second protruding cover 308. The first hole 344 and the second hole 346 may have shapes different to each other.

The first hole 344 and the second hole 346 may be disposed on a circumference in which a plurality of corresponding members 352a disposed at the top cover 340 are disposed. The first hole 344 and the second hole 346 may be disposed on a circumference in which a plurality of first magnetic members 328a are disposed at the upper cover 300. When the top cover 340 is mounted on the upper cover 300, the first hole 344 and the second hole 346 may be disposed between a plurality of magnetic members 328a, 328b.

The top cover 340 may be disposed at same position above the upper cover 300 when the first protruding cover 306 is inserted into the first hole 344 and the second protruding cover 308 is inserted into the second hole 346.

When the top cover 340 is mounted on the upper cover 300, an upper surface of the first protruding cover 306 may form a continuous surface (or parallel surface) with the cover plate 342 (of the top cover 340). When the top cover 340 is mounted on the upper cover 300, an upper surface of the second protruding cover 308 may form a continuous surface (or parallel surface) with the cover plate 342 of the top cover 340. When the top cover 340 is mounted on the upper cover 300, the upper surface of the first protruding cover 306 and the upper surface of the second protruding cover 308 may together form a flat surface.

When the top cover 340 is mounted on the upper cover 300, the cover plate 342, the first protruding cover 306, and the second protruding cover 308 may form an entirely flat surface.

The state in which the top cover 340 is mounted on the upper cover 300 may mean the first protruding cover 306 and the second protruding cover 308 are respectively inserted into the first hole 344 and the second hole 346. The state in which the top cover 340 is mounted on the upper cover 300 may be a state that the corresponding member 352a, 352b of the top cover 340 interact with the magnetic member 328a, 328b of the upper cover 300. The state in which the top cover 340 is mounted on the upper cover 300 may mean a state in which the top cover 340 and the upper cover 300 contact by the corresponding member(s) 352a, 352b and the magnetic member(s) 328a, 328b.

A plurality of ribs 350 that maintain a shape of the top cover 340 may be disposed at the top cover 340. The plurality of ribs 350 may protrude downward from a lower surface of the top cover 340. The plurality of ribs 350 may have shapes of circle concentric with respect to a center of the top cover 340. The plurality of ribs 350 may be radially formed with respect to the center of the top cover 340. The plurality of ribs 350 may be disposed between the plurality of corresponding members 352a, 352b.

The plurality of magnetic members 328a, 328b may be disposed at one of the top cover 340 or the upper cover 300. The plurality of corresponding members 352a, 352b may be disposed at the other one of the top cover 340 or the upper cover 300.

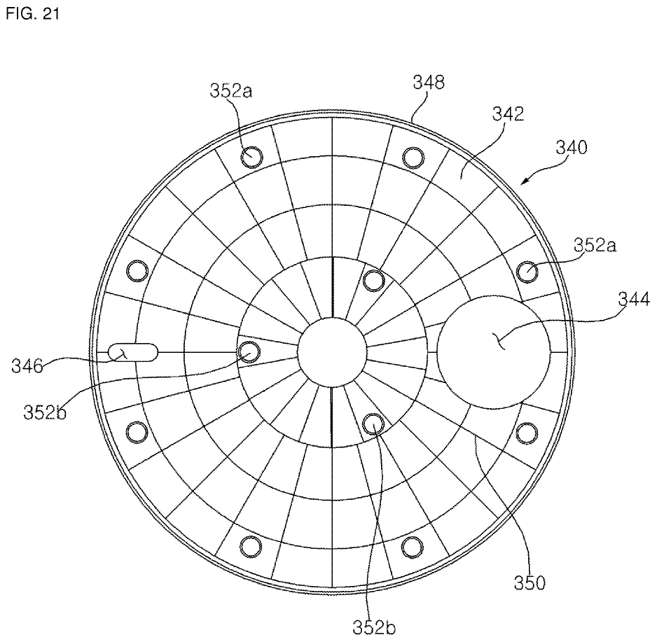

Referring to FIG. 21, the plurality of corresponding members 352a, 352b may be disposed at the top cover 340. The plurality of corresponding members 352a, 352b may include a plurality of first corresponding members 352a that are spaced apart from a center of the top cover 340 in a radial direction, and a plurality of second corresponding members 352b that are spaced closer apart from a center of the top cover 340 in a radial direction than the first corresponding member 352a. The plurality of first corresponding members 352a may be disposed to be spaced apart from each other in a circumferential direction. The plurality of second corresponding members 352b may be disposed to be spaced apart from each other in a circumferential direction.

Referring to FIG. 19, the first magnetic member 328a is disposed at a position corresponding to the first corresponding member 352a, and the second magnetic member 328b is disposed at a position corresponding to the second corresponding member 352b.

The plurality of magnetic members 328a, 328b may be disposed at the upper cover 300. The plurality of magnetic members 328a, 328b may be mounted on a lower surface of the upper cover 300. A magnetic member hook 329 for fixing the plurality of magnetic members 328a, 328b may be disposed at the upper cover 300.

Referring to FIG. 19, the plurality of magnetic members 328a, 328b may include a plurality of first magnetic members 328a spaced apart in a circumferential direction, and a plurality of second magnetic members 328b that is disposed on a circle concentric with a circle on which the plurality of first magnetic members 328a are arranged and spaced apart in a circumferential direction.

A gap between the plurality of first magnetic members 328a in the circumferential direction or a gap between the plurality of second magnetic members 328b in the circumferential direction may be formed to be longer than a radius gap L1 between a radius of concentric circle formed by the plurality of first magnetic member 328a and a radius of concentric circle formed by the plurality of second magnetic member 328b.

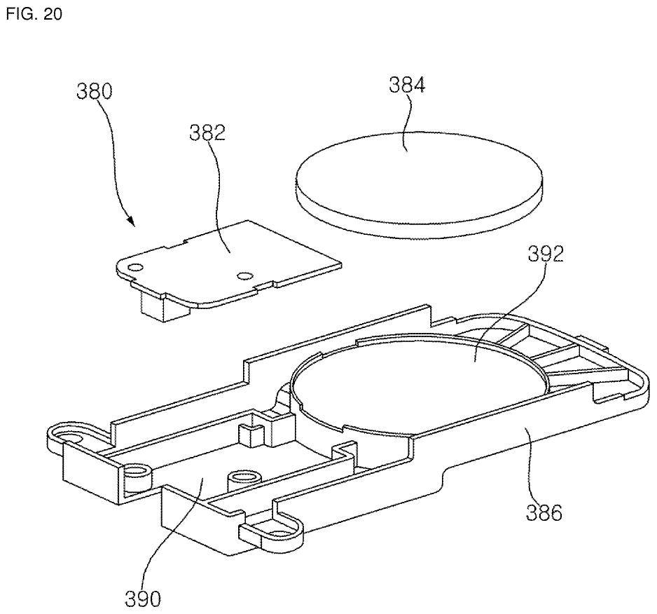

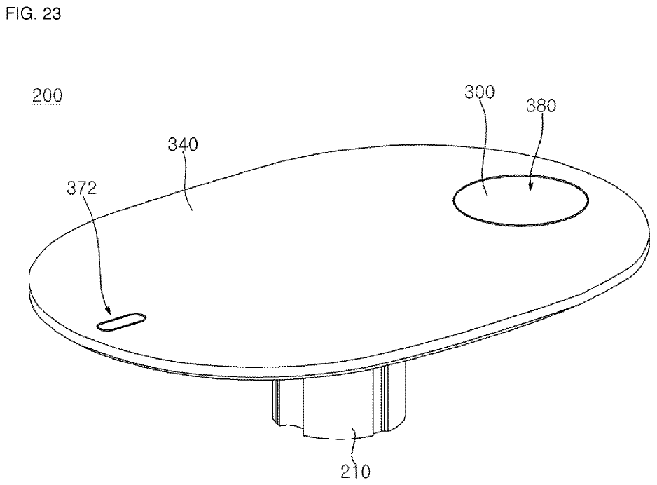

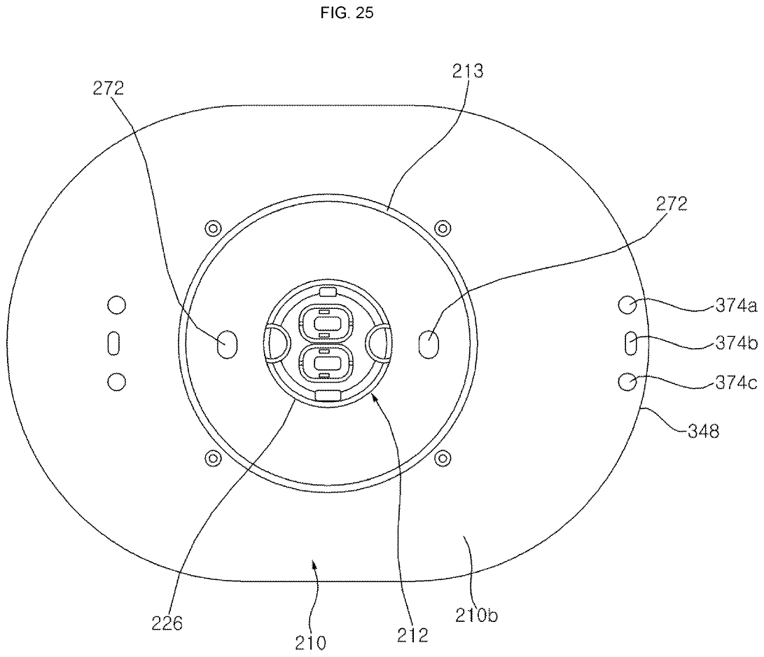

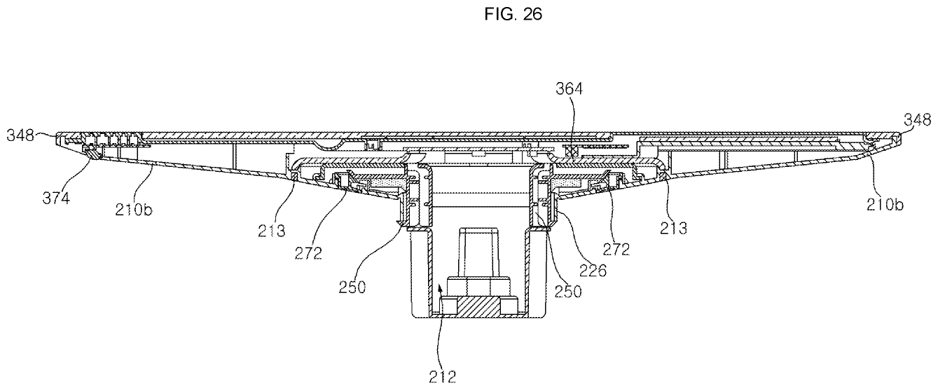

FIGS. 23 to 28 may show and describe a second body according to a second embodiment. The second body 200 according to the second embodiment may have same elements with the second body 200 according to the first embodiment. Referring to FIG. 20, the second body 200 may include the lower cover 210, the upper cover 300, and the top cover 340.

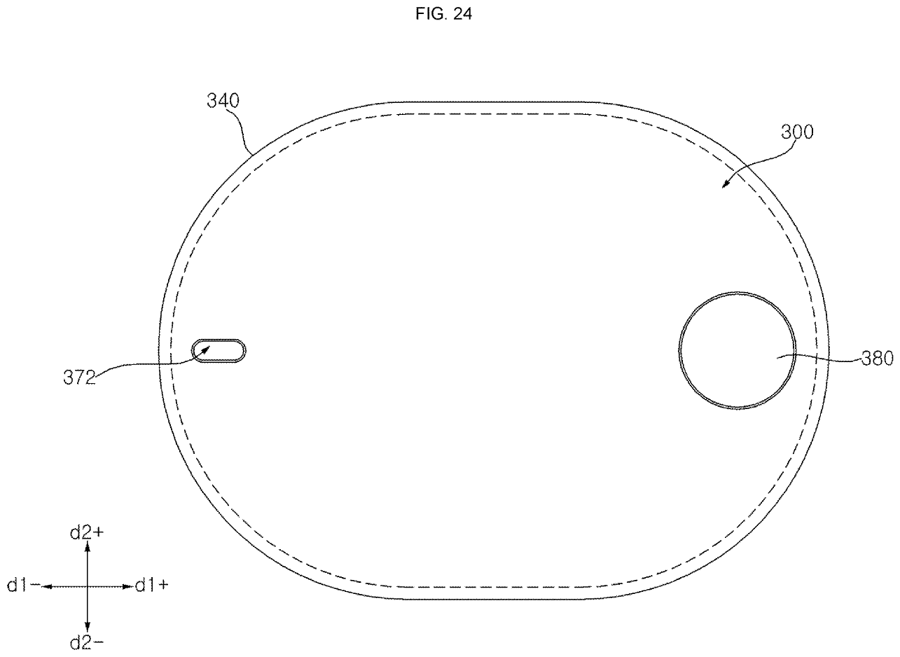

However, in aspect of shape, the second body 200 may have an oval shape when viewed from the top. Referring to FIG. 24, the second body 200 may have an oval shape elongated in a direction in which the charging unit 380 (or charging device) and the second lamp 372 are disposed. Referring to FIG. 21, a maximum radius thereof may be formed in a first direction d1+/d1− in which the charging unit 380 and the second lamp 372 are disposed, and a minimum radius thereof may be formed in a second direction d2+/d2− which is perpendicular to the first direction d1+/d1−.

The upper cover 300 may have an oval shape that covers an upper side of the lower cover 210. The upper cover 300 may include a plate, and at least one protruding cover 306, 308 protruding upwardly from the plate.

The top cover 340 may be disposed above the upper cover 300 and may have an oval shape.

The second body 200 may include the insertion pole 212. The insertion pole 212 may have a cylindrical shape, such as to be received in connection cover 156.

The second body 200 may include a lower surface 210b that is inclined relative to a horizontal plane. The second body 200 may include an boundary wall 348. The second body may include a press plate 272, and the press plate 272 may be exposed on a lower side of the lower surface 210b. The second body 200 may include a lamp (or light region) 213, and the lamp 213 may be exposed on a lower side of the lower surface 210b.

The second body 200 may include buttons 374a, 374b, 374c. The buttons 374a, 374b, 374c may be located closer to the boundary wall 348 than the outer circumferential surface 226. A distance between the buttons 374a, 374b, 374c and the outer circumferential surface 226 may be greater than a distance between the buttons 374a, 374b, 374c and the boundary wall 348. The buttons 374a, 374b, 374c may be located farther from the insertion pole 212 than the press plate 272. A distance between the buttons 374a, 374b, 374c and the insertion pole 212 may be greater than a distance between the buttons 374a, 374b, 374c and the press plate 272.

The press plate 272 and the buttons 374a, 374b, 374c may be located on a long axis of the lower cover 210. The horizontal section of the lower cover 210 may have an elliptical shape, and the press plate 272 and the buttons 374a, 374b, 374c may be arranged along the long axis of the lower cover 210.

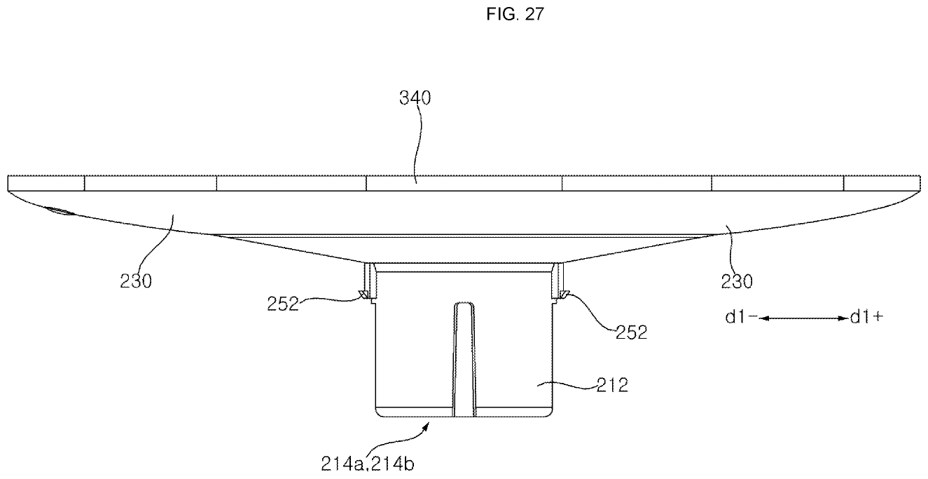

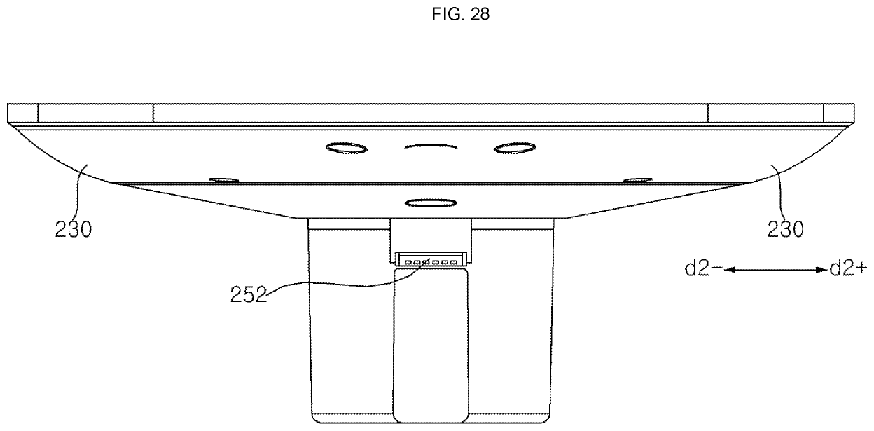

Referring to FIGS. 27 to 28, the lower cover 210 may include the guide wall 230 that guides air discharged from the outlet 174a in a radially outward direction (or outward directions) and the insertion pole 212 extending downwardly from a lower end of the guide wall 230 and inserted into the coupling groove 160a of the first body 100.

The insertion pole 212 may have a structure same as the first embodiment. That is, a hole in which the hook 252 protrudes may be disposed at a peripheral surface of the insertion pole 212. A corresponding pole terminal(s) 214a, 214b that is electrically connected to the connection terminal 158a, 158b disposed at the first body 100 may be disposed at the lower wall 214 (of the insertion pole 212). Therefore, regardless of a structure of the guide wall 230, the second body 200 of the second embodiment may be mounted on the coupling groove 160a of the first body 100.

Referring to FIGS. 27, 28, a portion of the guide wall 230 that extends along the second direction d2/d2− may be formed to be gentler than a portion of the guide wall 230 that extends along the first direction d1+/d1−.

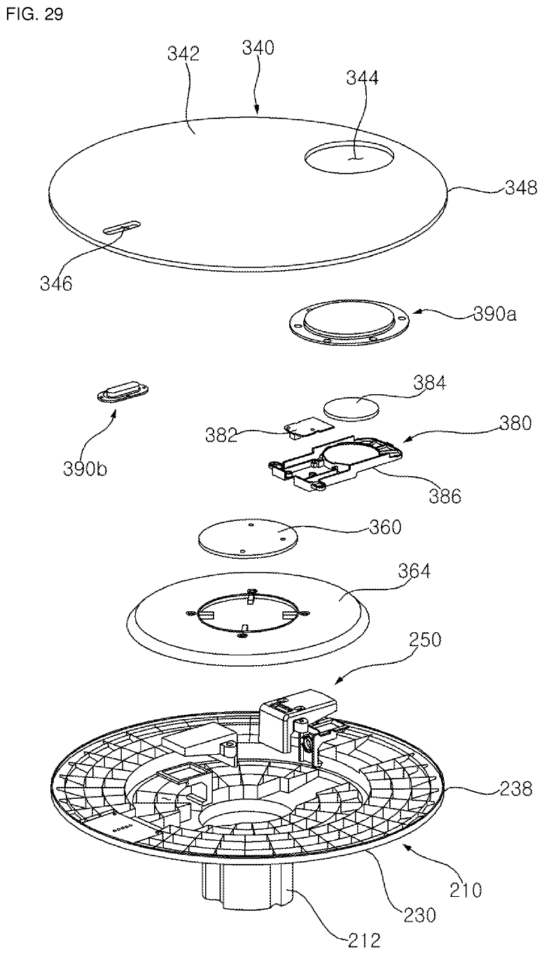

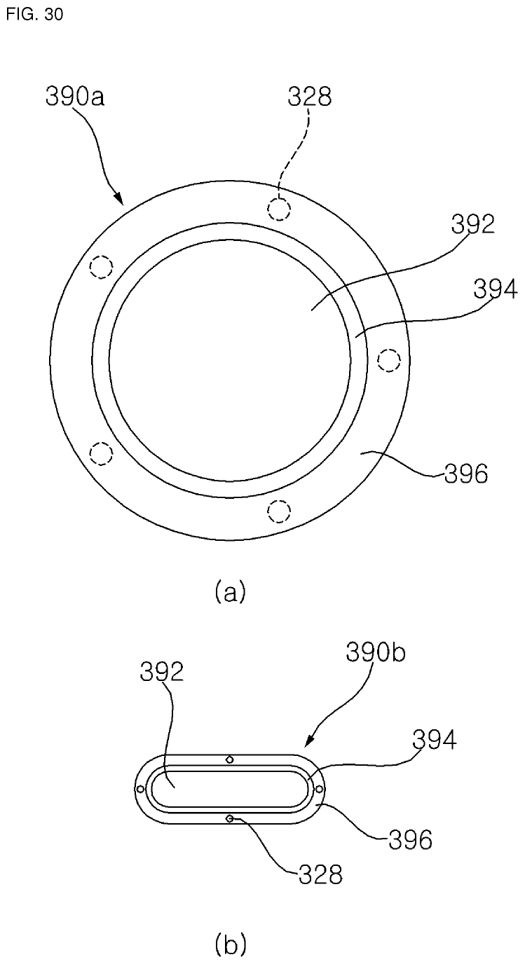

FIGS. 29, 30 may show and describe a second body 200 according to a third embodiment. The second body 200 of the third embodiment may include a hole cover 390a, 390b and excluding the upper cover from a structure of the second body 200 according to the first embodiment. The structure of the second body according to the third embodiment may be applied to a structure thereof according to the second embodiment.

Referring to FIG. 29, the second body 200 may include the lower cover 210, the coupling portion 250, the second lamp 372, the charging unit 380, and the top cover 340.

The second body 200 may be fixed to the lower cover 210 or the top cover 340 and may include a hole cover 390a, 390b mounted on the hole(s) 344, 346 formed at the top cover 340.

The first hole 344 and the second hole 346 may be formed at the top cover 340.

Referring to FIG. 29, the hole covers 390a, 390b may include a first hole cover 390a that is disposed at the first hole 344 and a second hole cover 390b that is disposed at the second hole 346. The first hole cover 390a may cover an upper side of the charging unit 380 that is disposed at the lower cover 210. The second hole cover 390b may cover an upper side of the second lamp 372 that is disposed at the lower cover 210. Each of the first hole cover 390a and the second hole cover 390b may be sized to correspond to the first hole 344 and the second hole 346, respectively.

Each of the first hole cover 390a and the second hole cover 390b may include an upper hole covers 392 that are respectively disposed at the first hole 344 and the second hole 346, and a lower hole cover 394 that is disposed below the top cover 340, and a connection plate 396 that extends from the lower hole cover 394 in radially outward directions.

FIG. 30 shows and describes a structure of the first hole cover 390a and the second hole cover 390b. Each of the first hole cover 390a and the second hole cover 390b may include an upper hole cover 392 that is disposed at the first hole 344, and a lower hole cover 394 that is disposed at an outer periphery of the upper hole cover 392 and which forms a groove depressed downward, and the connection plate 396 that extends from an outer periphery of the lower hole cover 394 in radial directions.

The upper hole cover 392 may have a cylindrical shape in which an upper side thereof is closed and that is flat. The upper hole cover 392 may include an upper peripheral wall 392b that extends downward along an edge of an upper plate 392a.

An upper surface of the upper hole cover 392 may form a continuous surface with an upper surface formed by the top cover 340.

The lower hole cover 394 may be disposed at a lower end portion of the upper hole cover 392. The lower hole cover 394 may have a structure that extends from a lower end portion of the upper peripheral wall 392b in radially outward directions. Therefore, the lower hole cover 394 may have a ring shape that extends along the outer periphery of the upper hole cover 392.

The lower hole cover 394 may have a shape of a groove that is depressed downward. Therefore, even if water spilled from an upper side of the top cover 340 moves downward through the first hole 344, the filled water may be prevented from entering into the lower cover 210.

The connection plate 396 may have a structure that extends from the lower periphery of the lower hole cover 394 in radially outward directions.

The connection plate 396 may be fixed to the lower cover 210 or the top cover 340.

The connection plate 396 may be fixed to the lower cover 210 and may have a magnetic member disposed thereat. In addition, a corresponding member may be disposed at a position corresponding to the magnetic member 328 at the top cover 340. Therefore, the top cover 340 may contact the lower cover 210 or the hole covers 390a, 390b when the top cover 340 is disposed above the lower cover 210.

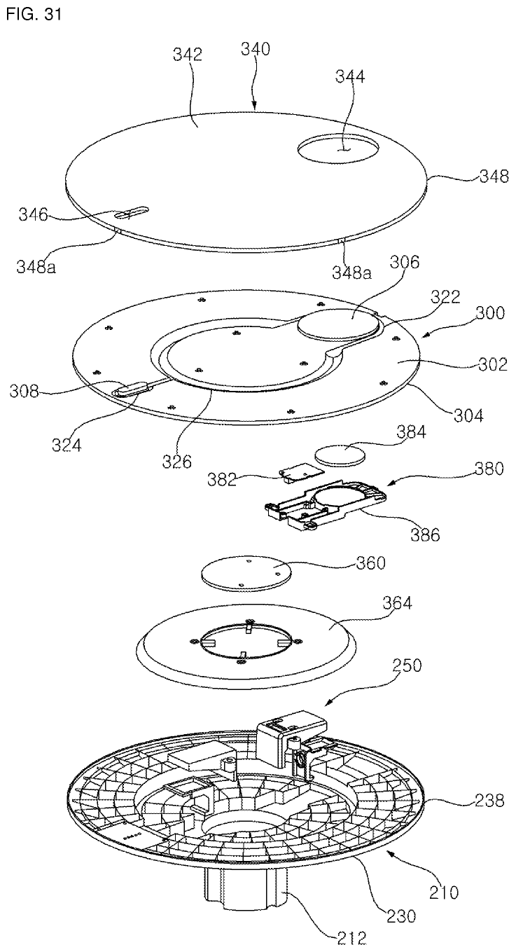

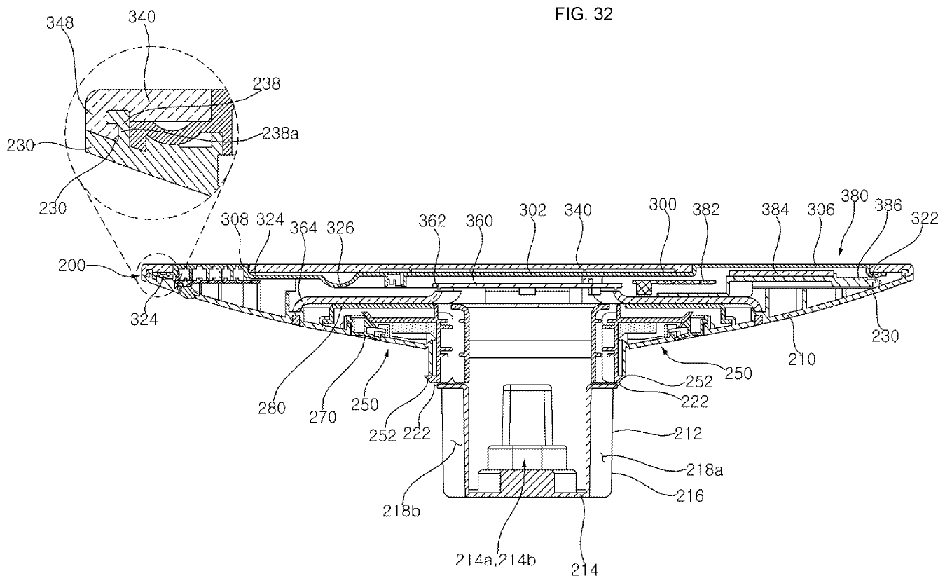

Referring to FIGS. 31, 32, a second body 200 according to a fourth embodiment may be described. The second body 200 according to the fourth embodiment may differ from the second body 200 according to the first embodiment in that the top cover 340 is coupled to one side of the lower cover 210.That is, the magnetic member and the corresponding member are deleted from the second body 200 according to the first embodiment and the top cover 340 is fixed to the lower cover 210 by another fastening structure.

Referring to FIG. 31, the second body 200 may include the lower cover 210, the upper cover 300, and the top cover 340. Other elements of the second body may be same with the elements of the first embodiment.

A top cover protrusion 348a fixed to the lower cover 210 may be disposed at the top cover 340. The top cover protrusion 348a may be disposed at a lower end portion of the boundary wall 348 of the top cover 340.

The top cover 340 may include a disc-shaped cover plate 342 and a boundary wall 348 that extends downwardly from an outer circumferential end of the cover plate 342 and the top cover protrusion 348a protruding radially inward is disposed at a lower end of the boundary wall 348. The top cover protrusion 348a may be formed at a whole surface of the boundary wall 348 or at a plurality of areas spaced apart in a circumferential direction.

A rib groove 238a in which the top cover protrusion 348a is inserted may be formed at the lower cover 210.

The lower cover 210 may include the guide wall 230 extending in radially outward directions above the outlet 174a and the edge rib 238 extending upwardly from an outer circumferential end of the guide wall 230, and the rib groove 238a may be formed at a lower end of the edge rib 238.

The rib groove 238a may be formed above the guide wall 230. Referring to FIG. 27, an outer circumferential end of the guide wall 230 may have a structure that protrudes further than a lower end of the edge rib 238 in a radially outward direction. Air discharged from the outlet 174a may flow from an inner circumferential end and an outer circumferential end of the guide wall 230 in a radially outward direction (or outward directions). The lower end portion of the boundary wall 348 of the top cover 340 may be disposed to contact an upper surface of the guide wall 230 when the top cover 340 is mounted on the lower cover 210.

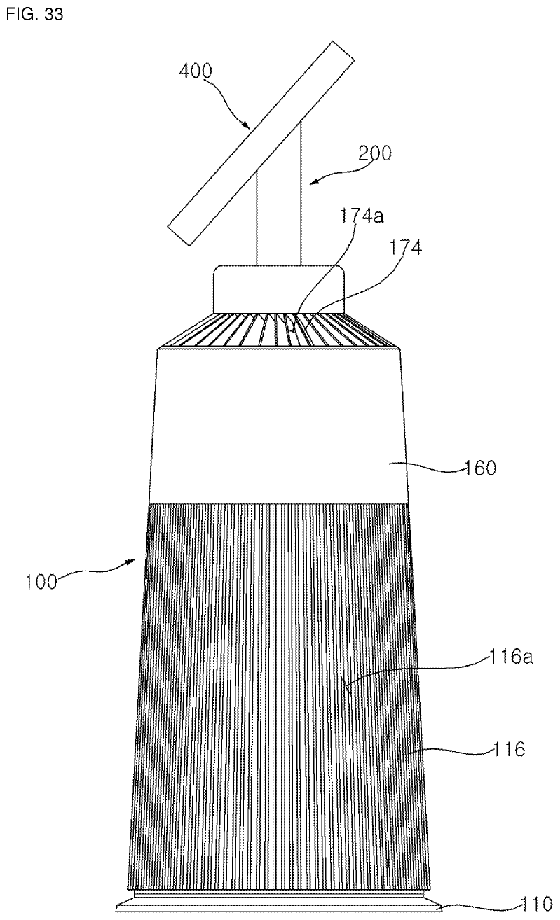

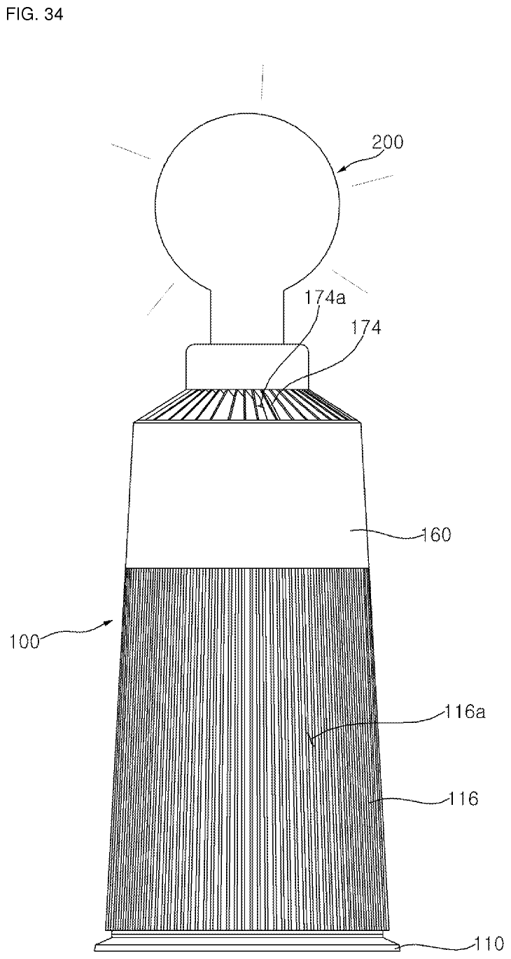

FIGS. 33 and 34 disclose that the second body 200 is mounted on an upper side of the first body 100 and that performs other function. Referring to FIG. 28, the second body 200 may perform a function of outputting an image or video. The second body 200 may include a structure of the insertion pole 212 and a display 400a may be disposed above the insertion pole 212.

The insertion pole 212 may have a structure that is fixed to the coupling groove 160a. The corresponding pole terminals 214a, 214b may be connected to the connection terminals 158a, 158b disposed at the coupling groove 160a when the insertion pole 212 is mounted on the coupling groove 160a of the first body 100.

Referring to FIG. 34, the second body 200 may perform as a light that emits light. The second body 200 may have a structure of the insertion pole 212, that is mounted on the first body 100, at a lower portion thereof and a light 400b may be disposed above the insertion pole 212.

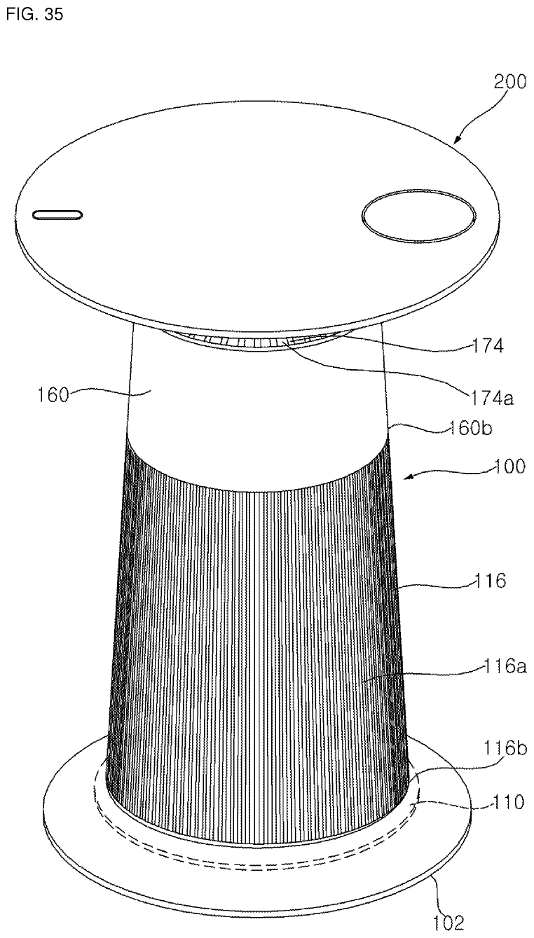

Referring to FIGS. 35 to 38, a base supporter 102 that prevents a turnover of the air cleaner may be described.

The first body 100 may further include the base supporter 102 that is fixed to one side of the first body 100 and that supports the air cleaner against the ground.

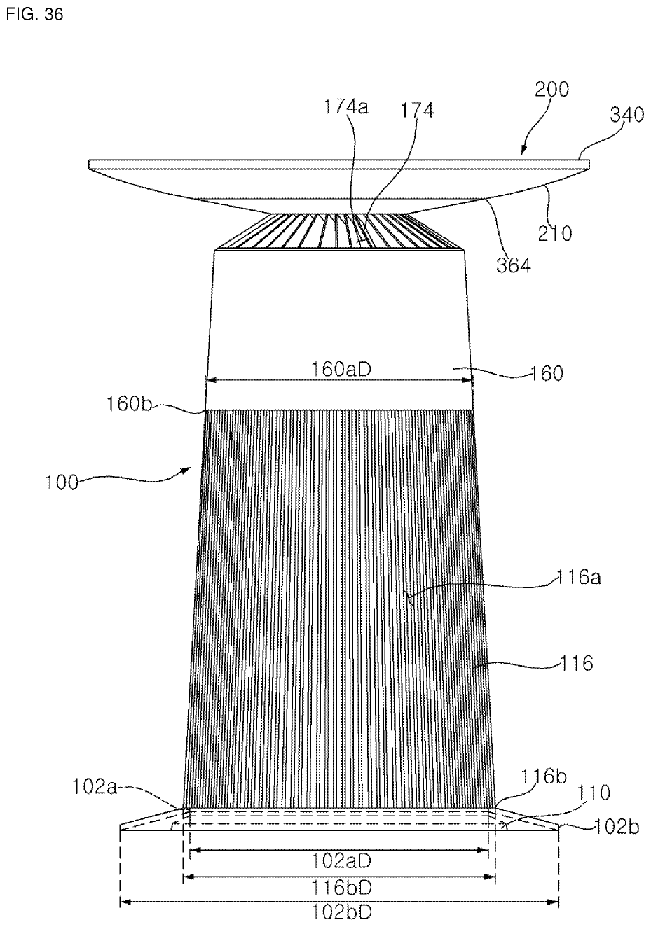

Referring to FIGS. 35 and 36, the base supporter according to the first embodiment may be opened in up-down direction and may have a cone shape that an upper end thereof is cut. The base supporter 102 may have a shape that a radius thereof expands as it goes upward.

Referring to FIG. 36, the base supporter 102 may be disposed under the inlet grille 116. The base supporter 102 may be disposed at an outer periphery of the base 110. The base supporter 102 may have a structure that is mounted on an upper side of the base 110.

Referring to FIG. 36, a diameter of an upper end portion 102a of the base supporter 102 may be smaller than a diameter of a lower end portion 116b of the inlet grille 116. Therefore, an upper end of the base supporter 102 may be fixed thereto. A lower end 102b of the base supporter 102 may be disposed to contact the ground. The diameter of the upper end portion 102a of the base supporter 102 may be larger than a diameter of a lower end portion 160a of the upper housing 160.

Therefore, the base supporter 102 may be inserted into an upper side of the base 110 in a state that the second body 200 and the inlet grille 116 are separated.

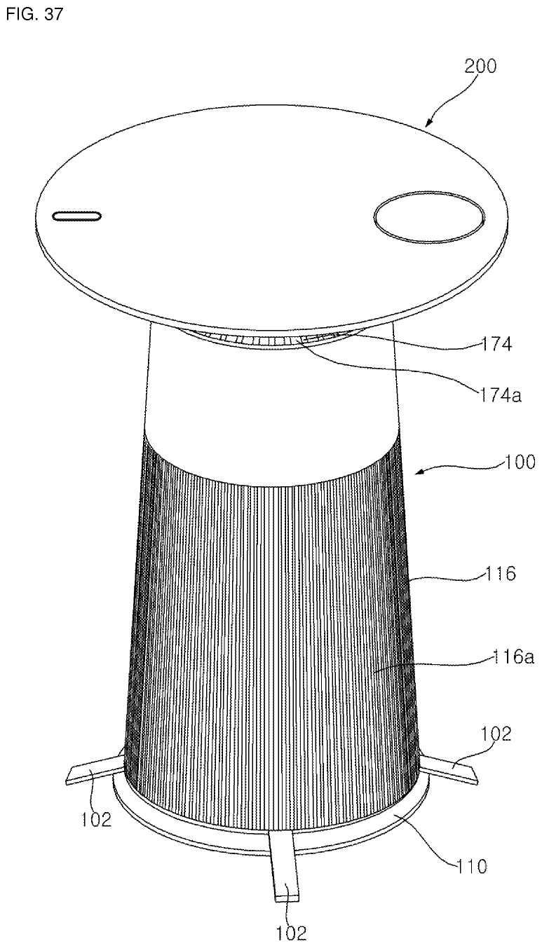

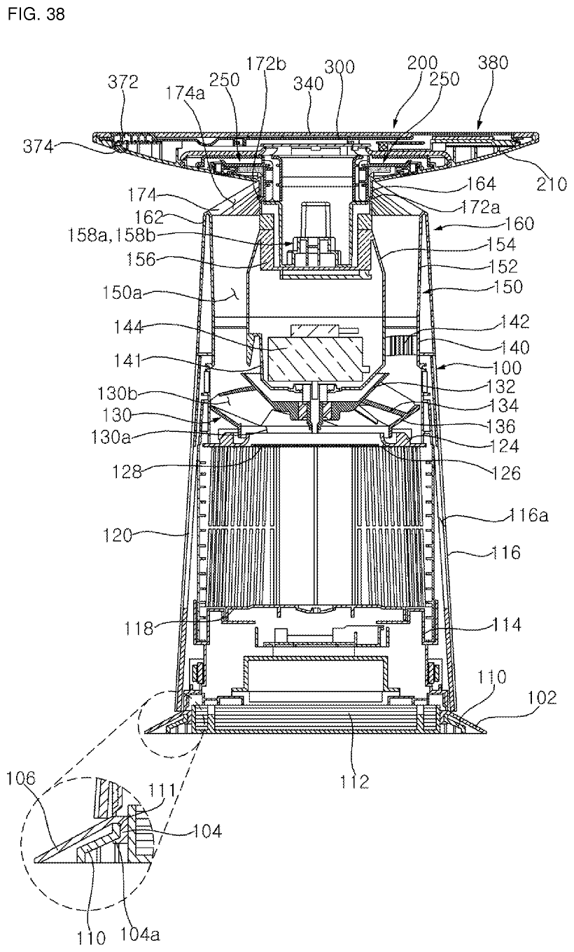

Referring to FIGS. 37 and 38, the base supporter 102 according to the second embodiment may have a bar-shaped structure separately mounted on the base 110.

A supporter groove 111 in which the base supporter 102 is mounted may be formed at the base 110.

Referring to FIG. 38, the supporter groove 111 in which one end portion of the base supporter 102 is mounted may be formed at the base 110.

Referring to FIG. 38, the base supporter 102 may include an insertion portion 104 that is inserted into the supporter groove 111 and an extension portion 106 extending in a radially outward direction (or outward direction) from an upper end of the insertion portion 104.

An engagement protrusion 104a that fixes the base supporter 102 to the supporter groove 111 may be formed at a lower end of the insertion portion 104. The engagement protrusion 104a may have a structure that protrudes in a radially outward direction from the lower end of the insertion portion 104.

The extension portion 106 may have a structure that is bent from an upper end of the insertion portion 104 and extends in a radially outward direction. The extension portion 106 may have a structure that extends downward as it goes away from the insertion portion 104. Therefore, an outer end of the extension portion 106 may have a structure that contacts the ground.

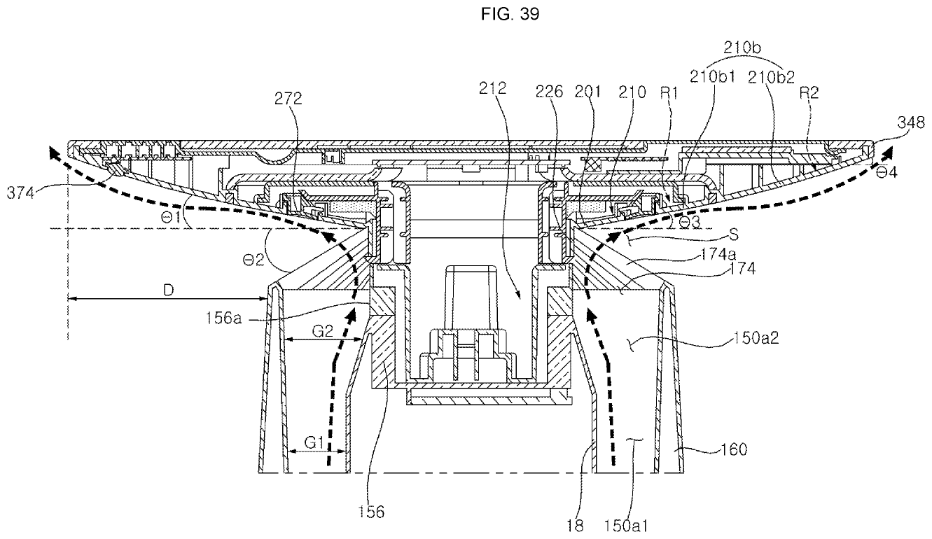

Hereinafter, the air purifier will be described with reference to FIG. 39. FIG. 39 is a cross-sectional view of an upper part of the air purifier cut in the vertical direction.

The discharge guider 150 may be spaced apart inward from the upper housing 160. The upward flow paths 150a1, 150a2 toward the outlet grille 174 may be defined between the upper housing 160 and the discharge guider 150. A width of the upward flow paths 150a1, 150a2 may increase in an upward direction (e.g., closer to outlet grille 174). The width G1 of the first upward flow path 150a1 may be smaller than the width G2 of the second upward flow path 150a2.

The connection cover 156 may include a connection cover outer wall 156a. The connection cover outer wall 156a may be spaced apart and inward from the upper housing 160. The second upward flow path 150a2 may be defined between the connection cover outer wall 156a and the upper housing 160. A space into which the insertion pole 212 is inserted may be defined inside the connection cover outer wall 156a. The second body 200 may be inserted into and fixed to an inner space of the connection cover outer wall 156a. The connection cover outer wall 156a and the outer circumferential surface 226 of the insertion pole 212 may define a continuous surface when the second body 200 is inserted into and fixed to an inner space of the connection cover outer wall 156a. The connection cover outer wall 156a may be disposed above the discharge guider 150.

Air blown by the fan 130 may flow upward between the upper housing 160 and the discharge guider 150. Here, the widths of the upward flow path 150a1, 150a2 may increase upward. The air flowing upward toward the outlet grille 174 may flow upward along the discharge guider 150 and the connection cover outer wall 156a. The air discharged into the discharge space S may flow toward the outer circumferential surface 226 of the insertion pole 212 along the outlet 174a. The air flowing along the outlet 174a may be guided upward by the outer circumferential surface 226. The air discharged into the discharge space S may flow along the lower surface 210b from the boundary portion 201. The air flowing along the lower surface 210b may flow upward by inclination of the lower surface 210b. Here, through shapes of the press plate 272 and the buttons 374 defined on the lower surface 210b, vortex may be suppressed due to the Coanda effect, and the straightness of the air flow may be improved.

The boundary wall 348 of the second body 200 may be located further outward than the upper housing 160 of the first body 100. A distance D may be defined between the boundary wall 348 and the upper housing 160. The inlet 116a may be defined along circumference of the upper housing 160. Accordingly, since the boundary wall 348 is located further outward than the upper housing 160, it is possible to prevent air flowing along the lower surface 210b from reintroducing into the inlet 116a.

The inclination angle θ1 at which the lower surface 210b is inclined with respect to the horizontal direction may be 30 degrees to 35 degrees. The angle at which the lower surface 210b is inclined with respect to the horizontal direction may increase toward outside of the second body 200. One angle θ3 at which the lower surface 210b is inclined at the boundary portion 201 may be smaller than another angle θ4 at which the lower surface 210b is inclined at the boundary wall 348. The angle at which the lower surface 210b is inclined with respect to the horizontal direction may increase from the boundary portion 201 toward the boundary wall 348.

The lower surface 210b may include a first lower wall (or first lower wall region) 102a facing the outlet grille 174 in the up-and-down direction, and a second lower surface 210b2 extending from the first lower surface 210b1 toward outside of the second body 200. The discharge space S may be defined between the first lower surface 210b1 and the outlet 174a. The second lower surface 210b2 may be located outward than the upper housing 160 of the first body 100.

A lower surface 210b may be curved. A first lower surface 210b1 may extend curvedly upward. A second lower surface 210b2 may extend curvedly upward. A radius of curvature of the lower surface 210b may decrease toward outside of the second body 200. The lower surface 210b may be curved upward toward the outside of the second body 200. A radius of curvature R1 of the first lower surface 210b1 may be greater than a radius of curvature R2 of the second lower surface 210b2.

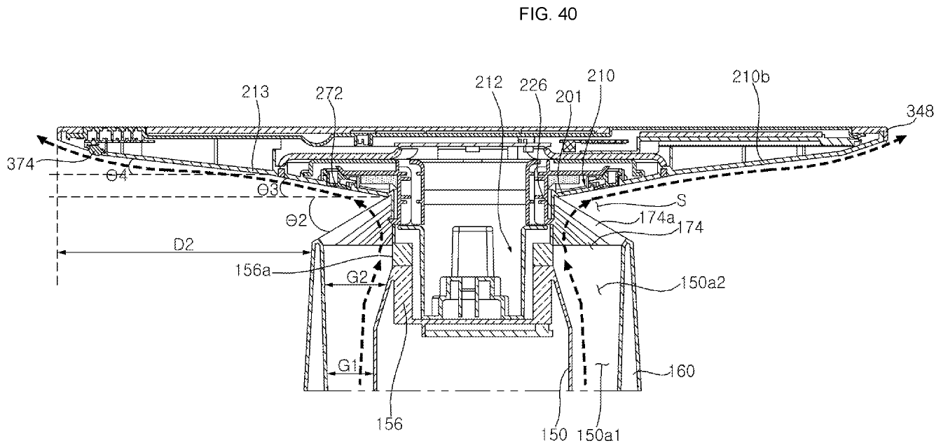

Hereinafter, the elliptical second body 200 will be described with reference to FIG. 40.

The press plate 272, the lamp 213, and the button 374 may be arranged along a direction in which the lower surface 210b extends. The press plate 272, the lamp 213, and the button 374 may be exposed on lower side of the lower surface 210b. The press plate 272, the lamp 213, and the button 374 may be sequentially arranged on the lower surface 210b extending from the outer circumferential surface 226 of the insertion pole 212 to the boundary wall 348 of the insertion pole 212.

After air blown by the fan 130 may be discharged into the discharge space S through the upward flow path 150a1, 150a2, the air may flow obliquely upward along the lower surface 210b.

The boundary wall 348 of the second body 200 may be located further outward in a radial direction from a center axis than the upper housing 160 of the first body 100. A distance D2 may be defined between the boundary wall 348 and the upper housing 160. A distance D2 between the boundary wall 348 and the upper housing 160 may be greater a distance D between the boundary wall 348 and the upper housing 160. The distance in which air discharge into the discharge space S flows along the lower surface 210b may be greater than that of air that flows along the lower surface 210b.

The lower surface 210b may be inclined upward toward an outside of the air purifier. The inclination angle of the lower surface 210b may decrease toward an outside of the air purifier. For example, an inclination angle θ3 between the insertion pole 212 and the press plate 272 may be greater than an inclination angle θ4 between the button 374 and the press plate 272. Accordingly, the generation of vortex may be suppressed due to the relatively longer length of the lower surface 210b compared to lower surface 210b.

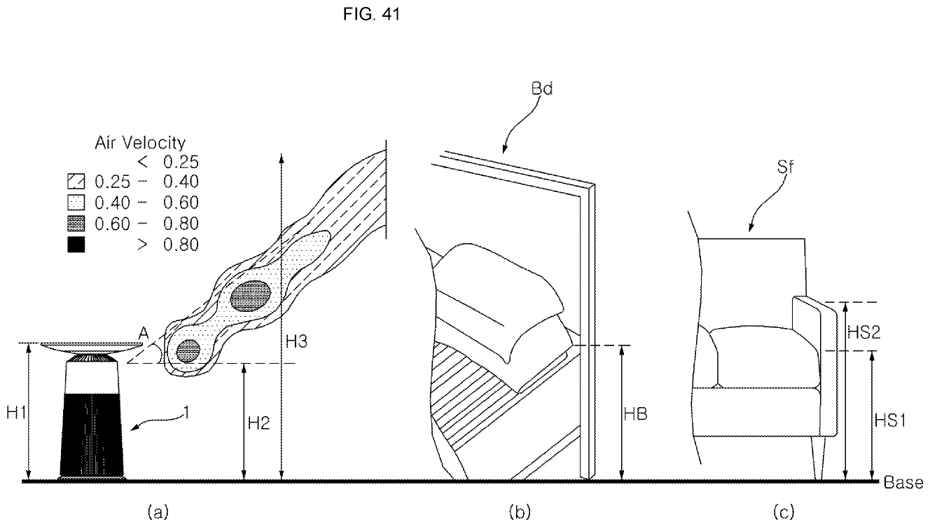

Hereinafter, functional attributes of the air purifier will be described with reference to FIG. 41. FIG. 41 (region a) is a diagram showing a direction of air flow discharged from the air purifier. FIG. 41 (region b) is a diagram for explaining a case where the air purifier is installed near a bed (Bd). FIG. 41 (region c) is a diagram for explaining a case where the air purifier is installed near a sofa (Sf).

A height H1 of the air purifier may be defined in a vertical direction, and the height H1 from a lower end to an upper end of the air purifier may be within a range of 50 cm to 60 cm. The outlet grille 174 of the air purifier may be spaced apart upward by a predetermined height H2 from the ground, and the height H2 of the outlet above the ground may be within a range of 35 cm to 45 cm. In one example, a maximum rising height H3 of air discharged from the air purifier may be within a range of 115 cm to 125 cm, but this height H3 may vary based on various factors.

An inclination angle A may refer to an angle at which air discharged from the air purifier is discharged upward with respect to the horizontal direction, and in one example, the inclination angle A may be within a range of 30 degrees to 35 degrees. For example, the lower surface 210b of the second body 200 may extend upward obliquely, and an inclination angle of the lower surface 210b may be within a range of 30 degrees to 35 degrees. Since the lower surface 210b are inclined, air discharged from the air purifier may have an upward inclination angle A. Since the air discharged from the air purifier has an upward inclination angle A, clean air can be supplied toward the user's vicinity without being directly delivered to the user. Accordingly, since the airflow of clean air is not directly delivered to the user but supplied to the user's vicinity, the user may feel more comfortable than when the airflow is directly delivered to the user.

The height at which the user's head touches the bed Bd may be spaced apart from the ground by a predetermined bed height HB, and an average of the height HB at which the user's head touches the bed Bd may be about 53.7 cm. The height at which the user sits on the sofa Sf may be spaced apart from the ground by a predetermined sofa seat height HS1, and an average of the heights HS1 at which the user sits on the sofa Sf may be about 40.9 cm. The height at which the armrests are located at the sofa Sf may be spaced apart from the ground by a predetermined sofa arm height HS2. An average of the height HS2 at which the armrests are located at the sofa Sf may be about 55.3 cm. Accordingly, if the air purifier of the present disclosure having a height of the outlet grille 174 from the ground is within a predetermined range near the bed Bd or the sofa Sf, since the discharged air has a predetermined inclination angle A, it is possible to prevent the flow of the discharged air from being directly delivered to the user when sleeping on bed Bd or sitting in chair Sf.

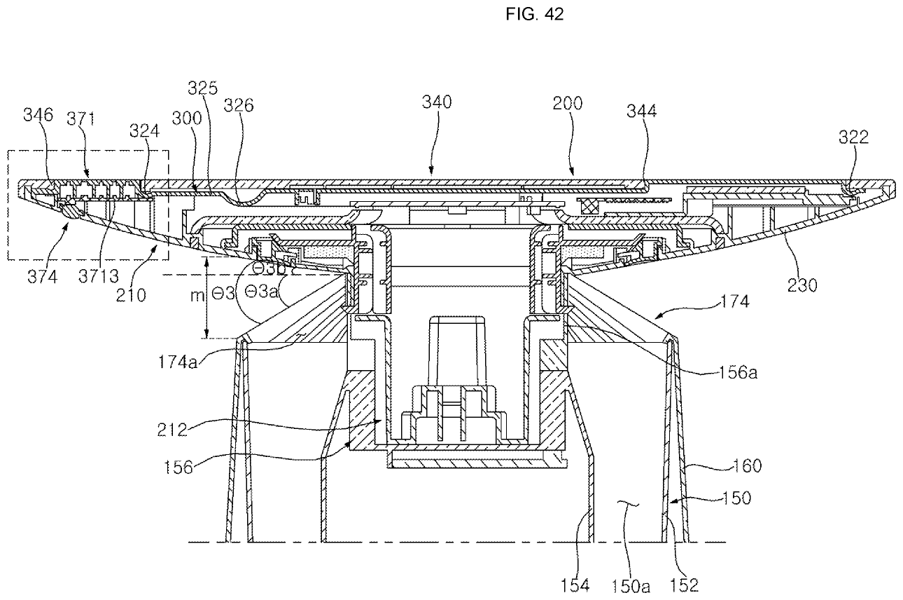

Referring to FIG. 42, aspects of the air cleaner will be described below. An outlet grille 174 (e.g., outlet cover) may be disposed toward the second body 200. The outlet cover may face the second body 200. The outlet grille 174 may be disposed at the top of the first body 100. The outlet grille 174 may define the upper surface of the first body 100.

The outlet grille 174 may be disposed to be spaced apart from the second body 200. The outlet grille 174 may be spaced apart from the lower cover 210 of the second body 200. The outlet grille 174 may be spaced apart from the lower cover 210 of second body 200 by a predetermined distance m. The lower cover 210 may be spaced upward from the outlet grille 174 by a predetermined distance m. A vertical separation distance m between the lower cover 210 and the outlet grille 174 may increase toward the outside of the first body 100. The outlet grille 174 may be the outlet grille 174. For example, the outlet grille 174 may be inclined downward toward the outside of the first body 100, the lower cover 210 may be inclined upward toward the outside of the first body 100, and a separation distance m between the outlet grille 174 and the lower cover 210 may increase toward the outside of the first body 100. In other examples, the outlet grille 174 may be an annular structure having holes for air transmission from outlet 174a.

The lower cover 210 may be convex downward. The guide wall 230 may be formed obliquely with respect to a radial direction of the second body 200. The guide wall 230 may be tilted with respect to the radial direction of the second body 200. The guide wall 230 may be inclined upward toward the edge. The guide wall 230 may be a curved surface. For example, the guide wall 230 may be convex downward. A curvature of the guide wall 230 may increase toward the edge of the second body 200. Accordingly, a discharge air flow may be generated along the guide wall 230 up to an edge of the lower cover 210 by the Coanda effect.

An angle Θ3b between the guide wall 230 and the radial direction of the second body 200 may be greater than zero. The angle Θ3b between the guide wall 230 and the radial direction of the second body 200 may be variable. The angle Θ3b between the guide wall 230 and the radial direction of the second body 200 may increase toward the edge of the guide wall 230.

An angle Θ3a between the outlet grille 174 and a radial direction of the first body 100 may be greater than zero. The angle Θ3a between the outlet grille 174 and the radial direction of the first body 100 may be greater than the angle Θ3b between the guide wall 230 and the radial direction of the second body 200. A difference between the angle Θ3a, which is formed by the outlet grille 174 and the radial direction of first body 100, and the angle Θ3b, which is formed by the guide wall 230 and the radial direction of the second body 200, may decrease toward the edge of the guide wall 230.

The outlet grille 174 may consist of a plurality of vanes 174c. A cross-sectional shape of the outlet grille 174 may correspond to a cross-sectional shape of the first body 100. For example, the first body 100 may have a cylindrical shape, and the outlet grille 174 may have annular shape corresponding to the first body 100.

The outlet grille 174 may be connected to the first body 100 and the second body 200. The outlet grille 174 may connect the upper housing 160 of the first body 100 and the lower cover 210 of the second body 200. The outlet grille 174 may be connected to an edge of the upper housing 160. The outlet grille 174 may be connected to one end of the lower cover 210.

The air cleaner may include an discharge guider 150 disposed inside the upper housing 160. The discharge guider 150 may be disposed inside the upper housing 160, and may be connected to the edge of the upper housing 160. For example, an upper edge of the discharge guider 150 may be connected to an upper edge of the upper housing 160.

The discharge guider 150 may include an upward flow path 150a. The discharge guider 150 may include an inner cover 152, which is an inner wall, and an inner housing 151, which is an outer wall. The upward flow path 150a may be defined by the inner guider 154 and the outer guider 152. The upward flow path 150a may be disposed between the inner guider 154 and the outer guider 152. For example, the discharge guider 150 may include a cylindrical inner guider 154, a cylindrical outer guider 152 having a greater diameter than the inner guider 154, and an annular upward flow path 150a formed between the inner guider 154 and the outer guider 152.

The outlet grille 174 may be disposed at an end of the upward flow path 150a. For example, the outlet grille 174 may be disposed at an end of the upward flow path 150a that is disposed at an upper side or part of the first body 100.

The first body 100 and the second body 200 may be selectively separated from each other. For example, the first body 100 may include a connection cover 156 to fix the second body 200. The connection cover 156 may be recessed downward from the upper surface of the first body 100. The connection cover 156 may be open on one side in the first body 100. For example, the connection cover 156 may be open at the top of the first body 100.

The connection cover 156 may be disposed at an upper side or part of the first body 100. The connection cover 156 may be disposed at a position corresponding to a center vertical axis of the first body 100. For example, the connection cover 156 may be formed in a cylindrical shape at the upper side of the first body 100, and may be disposed at a position corresponding to the center of the first body 100.

The connection cover 156 may include a connection cover outer wall 156a. The connection cover outer wall 156a may have a shape corresponding to the first body 100. The connection cover 156 may be smaller than the first body 100. For example, the connection cover 156 may be formed in a substantially cylindrical shape corresponding to the first body 100 and smaller than the first body 100.

The outlet grille 174 may be connected to the connection cover outer wall 156a. The connection cover outer wall 156a may be formed higher than the height of the first body 100.

The second body 200 may include the insertion pole 212 that is inserted into the connection cover 156 of the first body 100. The insertion pole 212 may have a shape corresponding to that of the connection cover 156, and may be smaller than the connection cover 156. The insertion pole 212 of the second body 200 may be inserted into and fixed to the connection cover 156. The connection cover outer wall 156a may be in contact with an outer surface of the insertion pole 212. For example, the insertion pole 212 may be formed in cylindrical shape to be smaller than the connection cover 156 with a cylindrical shape, so as to be fixed to the connection cover 156.

The second body 200 may include the top cover 340 with a flat surface. The second body 200 may include an upper cover 300 disposed between the lower cover 210 and the top cover 340.

The indicator 26 may be disposed at the upper surface of the second body 200. The indicator 371 (or indicator light) may face upward. The indicator 371 may be provided on the upper cover 300. The indicator 371 may protrude from the upper cover 300 toward the top cover 340. The indicator 371 may be inserted into the slot 241 formed in the top cover 340.

A substrate 3713 may be disposed at a bottom of the indicator 371. The substrate 3713 may allow the indicator 371 to be operated. The substrate 3713 may be connected to a controller. The indicator 371 may be disposed over a button 374. The indicator 371 and the button 374 may be arranged side by side in an up-and-down or vertical direction. The indicator 371 may visually output an indication of the operation of the button 374.

The button 374 may include a button 374a, 374b, 374c to receive a signal transmitted to the substrate 3713. The button 374a, 374b, 374c may be provided in plurality. The button 374 may include a connecting rod 3743 that connects the plurality of buttons 374a, 374b, 374c.

The button 374 may be disposed at the lower surface of the second body 200. The button 374 may be disposed to face downward. The button 374a, 374b, 374c may be spaced inward from the lower surface of the second body 200. The second body 200 may be provided with a button groove recessed upward from the lower surface thereof, and the button 374a, 374b, 374c may protrude downward from the button groove. The button 374a, 374b, 374c may define a section of the lower surface of the second body 200.

The button 374 may be disposed under the substrate 3713. The button 374 may be disposed at the lower cover 210. The button 374 may define a section of the guide wall 230. The button 374 may be disposed to correspond to a slope of the guide wall 230. For example, the guide wall 230 may be inclined upward toward the outside of the first body 100, and the button 374 may be disposed at an angle corresponding to an inclined angle of the guide wall 230. Accordingly, a discharge air flow moving along the guide wall 230 may reach the button 374, allowing a user to adjust the operation state of the air cleaner while feeling the intensity of discharged air with his or her hand.

The button 374 may be connected to the substrate 3713. The button 374 may be connected to the controller. The button 374 may be connected to the indicator 371. The button 374 may change the operation state of the air cleaner. For example, when a user presses the button 374, the operation of the air cleaner may start or stop.

The button 374 may be disposed adjacent to a circumferential end of the second body 200. The button 374 may be disposed closer to the circumferential end of the second body 200 than the insertion pole 212 of the second body 200. The button 374 may be located outward in the horizontal direction relative to the circumferential wall of the first body 100. For example, the button 374 may be disposed adjacent to the circumferential end of the lower cover 210 to be easily reached by the user. Accordingly, the user may easily access the button module hidden from view.

The button 374 may be disposed below the indicator 371. The substrate 3713 may be disposed between the button 374 and the indicator 371. The button 374, the substrate 3713, and the indicator 371 may be disposed side by side in the vertical direction. For example, the substrate 3713 may be disposed under the indicator 371, and the button 374 may be disposed under the substrate 3713. Accordingly, the indicator 371 disposed at the top surface may allow the user to easily determine the position of the button 374, which is hidden from view. Thus, an additional member connecting the button 374 and the substrate 3713 may not be required to operate the indicator 371. This may result in reducing the number of parts and achieving a simple structure.

The first protruding cover 306 may be provided on the upper cover 300. The first protruding cover 306 may protrude from the upper cover 300 toward the top cover 340. The first protruding cover 306 may be inserted into the first hole 344 formed in the top cover 340. A charging coil 272 may be disposed under the first protruding cover 306. The charging coil 272 may be disposed between the lower cover 210 and the upper cover 300. A charging substrate 273 may be adjacent to the charging coil 272, and may be disposed under the upper cover 300.

A water collection channel may be formed in the upper cover 300. The water collection channel may be formed under the top cover 340. The water collection channel may be formed between the top cover 340 and the upper cover 300. The water collection channel may be formed by being recessed from the upper cover 300.

The water collection channel may include a connection groove 326. The connection groove 326 may be disposed adjacent to a central portion of the upper cover 300. The water collection channel may include a second groove 324. The second groove 324 may be formed along a circumference of the indicator 371. The second groove 324 may be disposed under the second hole 346 formed in the top cover 340. The second groove 324 may be disposed under an edge of the second hole 346. Accordingly, liquid penetrated into a gap between the second hole 346 of the top cover 340 and the indicator 371 may be collected in the second groove 324.

The water collection channel may include a first groove 322. The first groove 322 may be formed along a circumference of the first protruding cover 306. The first groove 322 may be disposed under the first hole 344 formed in the top cover 340. The first groove 322 may be disposed under an edge of the first hole 344. The first groove 322 may be formed along a portion of the circumference of the first protruding cover 306.

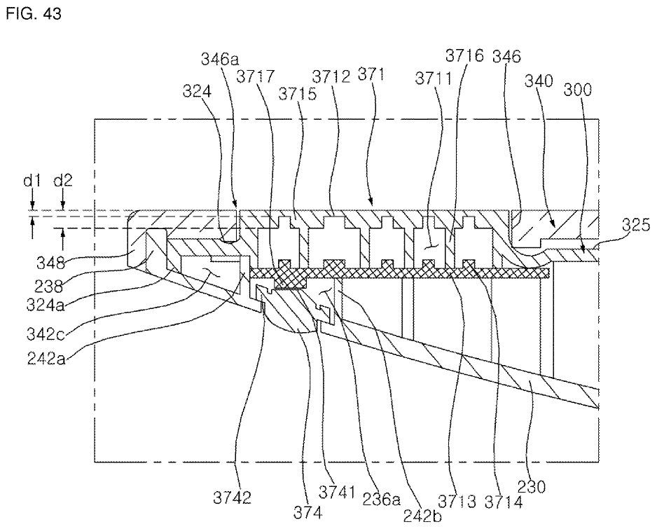

Referring to FIG. 43, aspects of the air cleaner will be described below. The button 374, the substrate 3713, and the indicator 371 may be disposed side by side in the vertical direction. The button 374, the substrate 3713, and the indicator 371 may be arranged in a line in the vertical direction. For example, the indicator 371 may be inserted into the second hole 346 of the top cover 340 to define a section of the upper surface of the top cover 340, the substrate 3713 may be disposed at the bottom of the indicator 371, and the button 374 may be disposed to be in contact with a lower surface of the substrate 3713.

The top cover 340 may include a boundary wall 348 that defines a lateral surface of the second body 200. An end of the top cover 340 may be bent to define the boundary wall 348. For example, the boundary wall 348 may be bent downward from the top cover 340 that defines the upper surface of the second body 200. The boundary wall 348 may cover a lateral portion of the lower cover 210.

The lower cover 210 may include a edge rib 238 formed by bending a lateral end thereof. The boundary wall 348 of the top cover 340 may cover the edge rib 238 of the lower cover 210. The boundary wall 348 of the top cover 340 may be in contact with the edge rib 238. The edge rib 238 of the lower cover 210 may be bent in a direction opposite to a direction in which the boundary wall 348 of the top cover 340 is bent. For example, the boundary wall 348 of the top cover 340 may be bent downward, and the edge rib 238 of the lower cover 210 may be bent upward.

The upper cover 300 may be disposed between the top cover 340 and the lower cover 210. The upper cover 300 may include a hooking rib 324a formed by bending a lateral end thereof to be coupled to the lower cover 210. The hooking rib 324a may be bent in a direction corresponding to a direction in which the boundary wall 348 of the top cover 340 is bent. The hooking rib 324a may be bent in a direction opposite to a direction in which the edge rib 238 of the lower cover 210 is bent. For example, the boundary wall 348 and the hooking rib 324a may be bent downward, and the edge rib 238 may be bent upward.

The hooking rib 324a, the edge rib 238, and the boundary wall 348 may be arranged sequentially from an inside to outside in the lateral direction. For example, the hooking rib 324a may be disposed to be in contact with an inner surface of the lower cover 210, and the boundary wall 348 may be disposed to be in contact with an outer surface of the lower cover 210. For example, the upper cover 300 may be in contact with the inner surface of the lower cover 210 by the hooking rib 324a and may be coupled from above to the lower cover 210. The top cover 340 may be disposed over the lower cover 210, so that the boundary wall 348 covers the edge rib 238 of the lower cover 210.

A gap 346a may be formed between the indicator 371 and the second hole 346. Liquid may enter the gap 346a between the indicator 371 and the second hole 346. The upper cover 300 may include the water collection channel for storing liquid introduced through the gap 346a between the indicator 371 and the second hole 346. The water collection channel may be disposed at a peripheral portion of the second hole 346. The water collection channel may be formed in the upper cover 300 in the form of a groove. The water collection channel may include the second groove 324 that is disposed under the second hole 346 along the circumference of the indicator 371, the connection groove 326 that is spaced apart from the central portion of the upper cover 300, and a connecting water collection channel 234 that connects the second groove 324 and the connection groove 326.

The indicator 371 may include a second protruding cover 308. The second protruding cover 308 may be elongated. The second protruding cover 308 may include a hollow portion 3711 in which a slot lamp 3714 is disposed. The hollow portion 3711 may be partitioned into a plurality of hollow portions 3711 by a housing partition wall 3716. A plurality of lamps 3714 may be provided in the second protruding cover 308. For example, the second protruding cover 308 may be partitioned into five hollow portions 3711 by four housing partition walls 3716, and five slot lamps 3714 may be disposed in the respective hollow portions 3711.

The second protruding cover 308 may be open on one side from the hollow portion 3711. The slot lamp 3714 may be disposed on the open side. The slot lamp 3714 may be coupled to the substrate 3713. The substrate 3713 to which the slot lamp 3714 is connected may be disposed on the open one side of the second protruding cover 308. The substrate 3713 may be in contact with the open side of the second protruding cover 308 to close or cover the hollow portion 3711. For example, the second protruding cover 308 may be opened downward from the hollow portion 3711, and the substrate 3713 to which the slot lamp 3714 is connected may be disposed at a bottom of the second protruding cover 308.

The slot lamp 3714 may be disposed between the substrate 3713 and the second protruding cover 308. The slot lamp 3714 may be disposed on the substrate 3713 to face the hollow portion 3711 so as to emit light. For example, the slot lamp 3714 disposed at the bottom of the second protruding cover 308 may emit light upward.

The second protruding cover 308 may include a housing upper wall 3715 that is inserted into the second hole 346 of the top cover 340. The housing upper wall 3715 may define a section of the upper surface of the top cover 340. The housing upper wall 3715 may have a shape corresponding to the second hole 346 of the top cover 340.

A groove 3712 may be formed in the housing upper wall 3715 of the second protruding cover 308. The groove 3712 may be formed inside the housing upper wall 3715. The groove 3712 may be recessed from the hollow portion 3711 to a direction opposite to the opening side of the second protruding cover 308. The hollow portion 3711 may be disposed between the groove 3712 and the opening. For example, the second protruding cover 308 may be open at the bottom, and the groove 3712 may be recessed upward.

A thickness d1 of the groove 3712 may be less than a thickness d2 of the housing upper wall 3715. The thickness d1 of the groove 3712 may be greater than zero. Light emitted from the slot lamp 3714 may pass through the groove 3712 and then be directed to the outside. Accordingly, information of the operation state of the air cleaner may be visually displayed to a user through the groove 3712, and liquid may be prevented from penetrating into the lamp housing.

The slot lamp 3714 may be connected to the substrate 3713. The slot lamp 3714 may be disposed on the substrate 3713. The plurality of lamps 3714 may be disposed on the substrate 3713 to be side by side in a longitudinal direction of the second protruding cover 308. For example, five slot lamps 3714 may be arranged in a row on the substrate 3713, so as to be respectively disposed in five hollow portions 3711 formed in the second protruding cover 308.

The slot lamp 3714 may be disposed below the corresponding groove 3712 of the second protruding cover 308. The slot lamp 3714 and the groove 3712 may be arranged in a line in the vertical direction. Light emitted from the slot lamp 3714 may pass through the groove 3712 located at an upper position and then spread to the outside.

The second protruding cover 308 may be elevated from the upper cover 300. The second protruding cover 308 may be integrated with the upper cover 300. The second protruding cover 308 may protrude from the upper cover 300 to be inserted into the second hole 346 to thereby define the upper surface of the top cover 340.

The button 374 may be in contact with the substrate 3713. The button 374, which is a surface opposite to a surface on which the slot lamp 3714 is disposed, may be in contact with the substrate 3713. For example, the slot lamp 3714 may be disposed on an upper surface of the substrate 3713, and the button 374 may be in contact with a lower surface of the substrate 3713.

The substrate 3713 may include a button sensor 3717 in contact with the button 374. The button sensor 3717 may be a pressure sensor configured to sense pressure. For example, when a user presses the button 374a, 374b, 374c, the button sensor 3717 may sense pressure to transmit a command to the controller.

The button 374 may include a button rib 3741 in contact with the substrate 3713. The button rib 3741 may be in contact with the button sensor 3717.

The lower cover 210 may include a button room 236a in which the button 374 is disposed. The lower cover 210 may include a second partition rib 242b and a first partition rib 242a that extend in the height direction of the first body 100. The second partition rib 242b and the first partition rib 242a may partition space in the second body 200 to defined the button room 236a in which the button 374a, 374b, 374c is disposed. The second partition rib 242b and the first partition rib 242a may have different heights.

The second partition rib 242b may define one side of the button room 236a, and may support the substrate 3713. The second partition rib 242b may be disposed adjacent to one side of the button 374. The first partition rib 242a may be disposed adjacent to another side of the button 374.

The first partition rib 242a may define another side of the button room 236a, and may support the upper cover 300. The first partition rib 242a and the guide wall 230 of the lower cover 210 may define a water collection portion 242c therein. The water collection portion 242c may be covered by the upper cover 300. Liquid that enters through the gap 346a between the second hole 346 and the indicator 371 may be primarily stored in the second groove 324 of the upper cover 300, and liquid that overflows from the second groove 324 and penetrates between the edge rib 238 and the hooking rib 324a may be secondarily stored in the water collection portion 242c. Accordingly, the waterproof performance of the air cleaner may be improved.

The lower cover 210 may include an opening formed at a bottom of the button room 236a to allow the button 374 to be coupled thereto. As the button 374 is inserted into the opening, the button 374a, 374b, 374c may be exposed to the outside.

The button 374 may include a flange 3742 seated on the guide wall 230 in the vicinity of the opening. The flange 3742 may extend in a lateral direction of the button 374. The flange 3742 may be disposed at the button room 236a, and the button 374a, 374b, 374c may be exposed to the outside. For example, the button 374 may approach the button room 236a from above, the flange 3742 may be seated on the guide wall 230 in the vicinity of the opening, and the button 374a, 374b, 374c may be exposed downward, namely, to the outside.

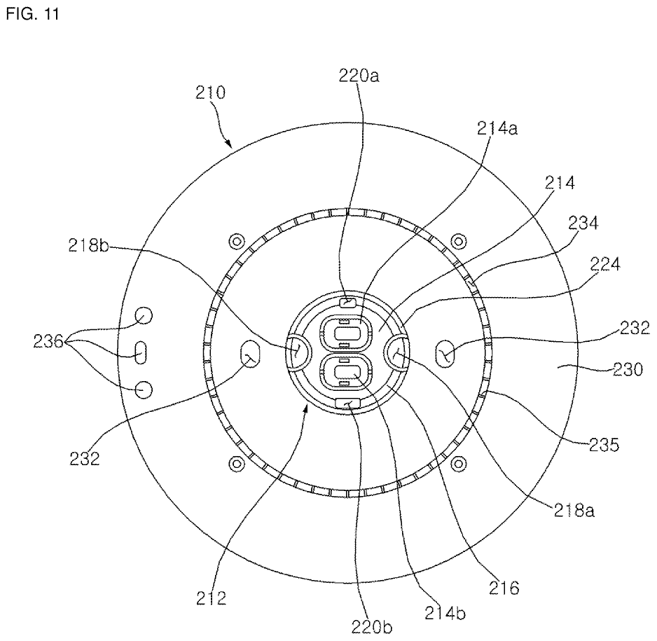

Referring to FIG. 11, aspects of the second body 200 will be described below. The button 374 may be disposed at the lower surface of the second body 200. The button 374 may define the lower surface of the second body 200. The button 374 may be disposed at the lower surface of the lower cover 210. The button 374 may define a section of the guide wall 230 of the lower cover 210. For example, the button 374 may be disposed at the lower surface of the second body 200 to face downward.

The button 374 may be disposed closer to the edge of the second body 200 than to the insertion pole 212. For example, a distance t2 between the button 374 and the insertion pole 212 may be greater than a distance t1 between the button 374 and the edge of the second body 200. The button 374 may be disposed relatively adjacent to the edge of the second body 200.

The button 374 may include a plurality of buttons 374. The plurality of buttons 374 may be disposed along the edge of the second body 200. The plurality of buttons 374 may be disposed in a circumferential direction of the second body 200. The plurality of buttons 374 may be disposed to be spaced inward from the edge of the second body 200 by a predetermined distance t1. For example, the button 374 may include three buttons 374a, 374b, 374c, and the three buttons 374a, 374b, 374c may be spaced inward from the edge of the lower cover 210 by a predetermined distance t, and may be disposed along the edge of the lower cover 210.

The button 374 may include a plurality of buttons 374 having different shapes. The plurality of buttons 374 may include a first button 374a having a first shape and a second button 374b having a second shape. For example, the plurality of buttons may include a first button 374a with a circular shape and a second button 374b with an elongated shape.

The button 374 may include a first button 374a, a second button 374b, and a third button 374c. The ordinal numbers do not indicate the order in which the buttons 374 are arranged. For example, the first button 374a, the second button 374b, and the third button 374c may not be sequentially arranged side by side.

Each of the plurality of buttons 374 may be concave or convex. The button 374 may be convex downward, and may protrude further than the lower surface of the second body 200. The button 374 may be concave upward, and may be depressed further than the lower surface of the second body 200. For example, the first button 374a may have a circular shape that is convex downward, the second button 374b may be elongated and convex downward, and the third button 374c may have a circular shape that is concave upward.

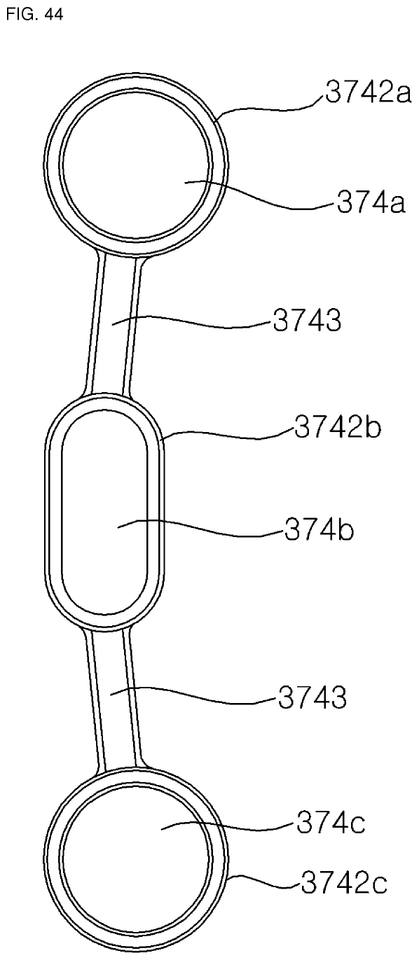

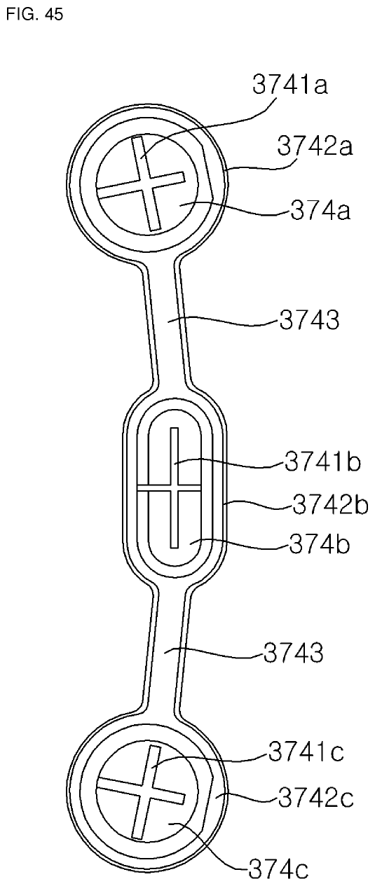

Referring to FIGS. 44 and 45, aspects of the button 374 will be described below. The button 374 may include a flange 3742 that extends from the button 374. The flange 3742 may extend along a circumference of each button 374. For example, a first button 374a and a third button 374c may each have a circular shape, and first and third flanges 3742a and 3742c may have circular shapes extending in respective lateral directions of the first and third buttons 374a and 374c. For example, a second button 374b may have an elongated shape, and a second flange 3742b may extend in a lateral direction of the second button 374b so as to have a shape corresponding to the shape of the second button 374b.

The button 374 may include a plurality of buttons 374 and a connecting rod 3743 that connects the plurality of buttons 374. The connecting rod 3743 may be connected to a flange 3742 of each button 374. For example, the connecting rod 3743 may connect a first flange 3742a of a first button 374a and a second flange 3742b of a second button 374b, and may connect the second flange 3742b of the second button 374b and a third flange 3742c of a third button 374c.

The connecting rod 3743 may obliquely connect the plurality of buttons 374 along a circumference of the second body 200. For example, a connecting rod 3743 that connects the first button 374a and the second button 374b, and a connecting rod 3743 that connects the second button 374b and the third button 374c may be disposed along the circumference of the second body 200, and may form an obtuse angle with each other.

The button 374 may include the button rib 3741 that protrudes inward (e.g., toward button sensor 3717) from an inner surface opposite to an outer surface exposed to the outside. The button rib 3741 may have a cross shape in which two ribs cross each other. The button rib 3741 may be disposed to face upward. The button rib 3741 may be in contact with the substrate 3713 disposed on top of the button 374. The button rib 3741 may activate the button sensor 3717 connected to the substrate 3713. For example, when a user presses the button 374, the button rib 3741 may activate the button sensor 3717, and the substrate 3713 may transmit a signal to the controller.

Referring to FIG. 19, aspects of the upper cover 300 will be described below. The upper cover 300 may have a shape of the upper surface of the second body 200. The upper cover 300 may have a circular shape or may have an oval or elliptical shape. The upper cover 300 may be a plate having a predetermined thickness. The upper cover 300 may include the second protruding cover 308. The upper cover 300 may include the first protruding cover 306.

The second protruding cover 308 may be formed by protruding from the upper cover 300. The first protruding cover 306 may be formed by protruding from the upper cover 300.

The upper cover 300 may include the water collection channel. The water collection channel may be a groove formed in the upper cover 300. The water collection channel may be recessed downward from the upper cover 300. The water collection channel may include the connection groove 326 spaced apart from the central portion of the upper cover 300 in the lateral direction to be formed along a circumferential direction of the upper cover 300. For example, the connection groove 326 may be spaced apart from a central portion of a circular upper cover 300 to extend in a circumferential direction of the upper cover 300, and may be recessed downward.

The water collection channel may include the second groove 324 formed along a circumference of the second protruding cover 308. The second groove 324 may be shallower than the connection groove 326. A width of the second groove 324 may be less than a width of the connection groove 326.

The water collection channel may include the first groove 322 formed along the circumference of the first protruding cover 306. The first groove 322 may be shallower than the connection groove 326. A width of the first groove 322 may be less than the width of the connection groove 326. The first groove 322 may be formed along a portion of the circumference of the first protruding cover 306, and may be connected to the connection groove 326. For example, the first groove 322 may be formed in a ‘C’ shape along a half of the circumference of the first protruding cover 306, and may be connected to the connection groove 326.

As can be appreciated, the terminology used above may not be limited, and other terms may be used in accordance with terminology used in this field of endeavor. The outlet grille 174 may also be referred to as the outlet 174. The upward flow path 150a may also be referred to as the discharge passage 150a. The outlet 174a may also be referred to as the outlet grille 174a. The outlet top 174b may also be referred to as the grille top 174b. The upper housing 160 may also be referred to as the outer wall 160. The discharge guider 150 may also be referred to as the housing 150. The inner guider 154 may also be referred to as the first housing wall 154. The outer guider 152 may also be referred to as the second housing wall 152. The guide vane 142 may also be referred to as the diffuser 142. The connection cover 156 may also be referred to as the mount 156(or mount opening). The connection cover outer wall 156 a may also be referred to as the mount outer wall 156a. The lower surface 210b may also be referred to as the lower wall 210b. The boundary wall 348 may also be referred to as the edge 348. The insertion pole 212 may also be referred to as the lower body 212. The lower cover 210 may also be referred to as the upper body 210. The guide wall 230 may also be referred to as the plate 230. The coupling portion 250 may also be referred to as the coupling device 250 (or coupler). The press plate 272 may also be referred to as the coupling device button 272. The light source guide 364 may also be referred to as the light guide 364. The first board 360 may also be referred to as the substrate 360. The button 374 may also be referred to as the button assembly 374. The charging unit(charging device or charger) 380 may also be referred to as the wireless charging device 380. The plate 302 may also be referred to as the top plate 302 (or intermediate plate). The first protruding cover 306 may also be referred to as the wireless charging portion 306 (or wireless charging region). The second protruding cover 308 may also be referred to as the display 308.

The fan 130 may also be referred to as the blower fan 130. The discharge guider 150(discharge guide) may also be referred to as the inner body 150. The outer guider 152 may also be referred to as the inner housing 152. The inner guider 154 may also be referred to as the inner cover 154. The upward flow path 150a may also be referred to as the outlet passage 150a. The connection cover 156 may also be referred to as the holder 156. The connection cover outer wall 156a may also be referred to as the holder wall 156a. The insertion pole 212 may also be referred to as the post 212. The fastening rib groove 218 may also be referred to as the guide groove 218. The second partition rib 242b may also be referred to as the first partition wall 242b. The first partition rib 242a may also be referred to as the second partition wall 242a. The edge rib 238 may also be referred to as the lateral wall 238. The upper cover 300 may also be referred to as the upper plate 300. The connection groove 326 may also be referred to as the main water collection channel 326. The second groove 324 may also be referred to as the slot water collection channel 324. The first groove 322 may also be referred to as the pad water collection channel 322. The third groove 325 may also be referred to as the connecting water collection channel 325. The top cover 340 may also be referred to as the plate 340. The second hole 346 may also be referred to as the slot 346. The first hole 344 may also be referred to as the pad hole 344. The boundary wall 348 may also be referred to as the lateral cover 348. The second protruding cover 308 may also be referred to as the lamp housing 308. The first protruding cover 306 may also be referred to as the charging pad 306. The charging pad 384 may also be referred to as the charging coil 384. The third board 382 may also be referred to as the charging substrate 382. The inner plate 386 may also be referred to as the charging case 386.

An objective may be to provide the filtered air quickly and widely to the indoor space and to provide an air cleaner capable of utilizing a space above the air cleaner.

Another objective may be, in a structure that comprises a first body performing air cleaning function and a second body above the first body to function as a table, to minimize entry of foreign substance falling from the second body into the first body.

Another objective may be, in a structure that the second body comprises a lower cover, an upper cover and a top cover, to provide an air cleaner that prevents foreign substances from entering inside of the lower cover.

Another objective may be to provide an air cleaner that has a structure that the upper cover covering an upper side of the lower cover is capable of accommodating falling foreign substances as much as possible.

Another objective may be to provide an air cleaner that minimizes an entry of foreign substances through a gap between the upper cover and the top cover.

Another objective may be to provide an air cleaner that has a structure preventing foreign substances entering inside the lower cover from moving to a space where electronics units of the lower cover are disposed.

Another objective may be to provide an air cleaner that prevents foreign substances falling from the second body from entering inside the first body.

Another objective may be to prevent air discharged from an air purifier from being directly supplied to a user.

Another objective may be to guide a flow direction of air discharged through an outlet.

Another objective may be to minimize resistance of air discharged through an outlet.

Another objective may be to prevent air discharged through an outlet from re-introducing into an inlet.

Another objective may be to prevent vortex flow in a region near an outlet.

Another objective may be to provide an air cleaner with improved installation convenience for a worker.

The objectives are not limited to the objectives mentioned above, and other objectives not mentioned would be clearly understood from the following description by those who skilled in the art.

To achieve the objectives above, an air cleaner according to embodiment may comprise a first body that an inlet is formed at a peripheral surface thereof and that an outlet is formed above the inlet; a second body disposed above the first body and guiding air discharged from the outlet in a radially outward direction, wherein the second body may comprises: a lower cover disposed above the outlet and extending upwardly as it goes in a radially outward direction; a top cover disposed separably to the lower cover; an upper cover disposed between the lower cover and the top cover and comprising a plate and a protruding cover that protrudes upward from the plate, wherein a hole opened in up-down direction is formed at the top cover such that the protruding cover is disposed, wherein a groove is formed at the plate, the groove depressed downward at a periphery of the protruding cover. It is possible to temporarily store foreign substances introduced through a gap between the top cover and the upper cover.

The upper cover may comprise a plurality of protruding covers spaced apart from each other at the plate, and wherein a plurality of grooves are formed at the plate, each of the plurality of grooves depressed downward at the periphery each of the plurality of protruding covers. It is possible to temporarily store foreign substance introduced through the hole in the groove.

A connection groove may be formed to be depressed downward at the plate, and the connection groove connects each of the plurality of grooves. It is possible to additionally secure a space at the upper cover for storing foreign substance.

An area formed by the connection groove may be larger than an area formed by each of the plurality of grooves.

A depth, depressed downward from the plate, of the connection groove may be longer than a depth, depressed downward from the plate, of each of the plurality of grooves.

The plurality of grooves may be spaced apart from each other in a circumferential direction, and wherein the connection groove disposed between the plurality of grooves and has a ring shape.

A plurality of magnetic members that bring the top cover into close contact with the upper cover may be disposed at the top cover or at the upper cover, and wherein the hole is disposed between the plurality of magnetic members. It is possible to closely contact the top cover and the upper cover.

The plurality of magnetic members may comprise a plurality of first magnetic members spaced apart in a circumferential direction; and a plurality of second magnetic members disposed spaced apart in a circumferential direction on a concentric circle having a different radius from a circle formed by the plurality of first magnetic members.

The top cover may comprise a cover plate that is disposed above the upper cover and a boundary wall that extends downwardly at an outer periphery of the cover plate, and wherein the boundary wall is disposed outside of a peripheral surface of the lower cover. It is possible to prevent foreign substance flowing along the outer periphery of the top cover entering into the lower cover.

The lower cover may be bowl-shaped forming a space in which electronic units are disposed, wherein the lower cover comprises an edge rib that forms an outer circumferential wall at an upper end portion thereof and a plurality of partition ribs that extends upward from an upper surface thereof and that has different radii, and wherein the boundary wall is disposed at an outer periphery of the edge rib. The foreign substance moving from the upper cover to the lower cover can be stored in an outermost portion of the lower cover.

The plurality of partition ribs may comprise a first partition rib disposed to face the edge rib, and wherein an outer circumferential end of the upper cover is disposed between the edge rib and the first partition rib.

An area formed by an upper surface of the top cover may be larger than an area formed by the outlet. It is possible to prevent the foreign substance moving downward from the second body from entering into the outlet of the first body.

An air cleaner according to the embodiment may comprise a first body that an inlet is formed at a peripheral surface thereof and that an outlet is formed above the inlet; and a second body disposed above the first body and guiding air discharged from the outlet in a radially outward direction, wherein the second body comprises: a lower cover disposed above the outlet and extending upwardly as it goes in a radially outward direction; a top cover that is separably disposed from the lower cover and that a hole is formed at one side thereof; and a hole cover disposed to be inserted into the hole formed at the top cover, wherein the hole cover comprises an upper hole cover that is disposed at the hole, and a lower hole cover that extends in a radial direction at an outer periphery of the upper hole cover to be disposed under the top cover and that forms a groove depressed downward. The foreign substance introduced through the hole can be stored in a space of the groove of the hole cover.

The hole cover may comprise a connection plate that extends outward of the lower hole cover and that is mounted on the top cover.

A magnetic member that is disposed to be fixed to the lower cover and that makes the hole cover to contact to the groove formed at the top cover may be disposed at the connection plate.

The connection plate may be disposed to be fixed to a lower surface of the top cover.

An air cleaner according to an embodiment may comprise a first body that an inlet is formed at a peripheral surface thereof and that an outlet is formed above the inlet; a second body disposed above the first body and guiding air discharged from the outlet in a radially outward direction, wherein the second body comprises: a lower cover disposed above the outlet and bowl-shaped to accommodate electronic units therein; and an upper cover disposed above the lower cover, wherein the lower cover comprises: a guide wall that is disposed above the outlet and that a diameter thereof expands as it goes upward; an edge rib protruding upwardly from an upper end of the guide wall; and a plurality of partition ribs that extends upwardly from an upper surface of the guide wall, each of the plurality of partition ribs extends in different radial directions, wherein the plurality of partition ribs comprises a first partition rib disposed to face the edge rib, and wherein an outer circumferential end of the upper cover is disposed between the edge rib and the first partition rib.

The air cleaner may further comprise a top cover that is disposed at the air cleaner and that is separable from the lower cover, and wherein a boundary wall extending downwardly from an outer circumferential end of the top cover may be disposed outside of a peripheral surface of the lower cover.

A plurality of magnetic members that make the top cover to contact the upper cover may be disposed at the top cover or at the upper cover.

Details of the embodiments and the like are included in the detailed description and drawings.

According to an air cleaner, following effects one or more.

It is possible to quickly diffuse the filtered air to the indoor space by disposing a second body above the air cleaner that discharges the filtered air upward and by guiding air discharged from the outlet in a radial direction. In addition, since the first body has a structure that the second body is coupled to an inside of the outlet, it is possible to utilize the space above the air cleaner.

By placing the second body that guides air upwardly and functions as a table, it is possible to utilize the second body as a table. In addition, the second body has the advantage that electronics units disposed inside the lower cover can be stably disposed by covering an upper side of the lower cover with two elements of the upper cover and the top cover.

Even if a foreign substance such as fluid spilled by a stuff placed on the table flows into a gap between the top cover and the upper cover, it is possible to temporarily store it by the groove formed at the upper cover. Since this can prevent fluid or the like from entering an inside of the lower cover, there is an advantage in that the electronic units disposed inside the lower cover can reliably operate. In addition, since the top cover and the upper cover are in close contact with each other by a magnetic member, it is possible to minimize that an inflow of foreign substances falling from the top cover enter into a gap between the upper cover and the top cover.

The upper cover includes a connection groove forming a larger groove in addition to the groove formed at an outer periphery of a protruding cover, so that foreign substances falling from the upper side of the top cover can be accommodated as much as possible.

Since the lower cover includes a plurality of partition ribs to partition the inside of the lower cover and the upper cover has a structure extending to an outside of the partition rib of the lower cover, it is possible to prevent the foreign substances entering into the upper cover from flowing into the lower cover. There is an advantage in securing the reliability of electronic units disposed inside the lower cover.

Since an area of an upper end of the second body is larger than an area of the outlet of the first body, it is possible to prevent foreign substances falling from the stuff placed on the upper side of the second body from flowing inside of the first body.

It is possible to prevent air discharged from an air purifier from being directly supplied to a user.

It is possible to guide a flow direction of air discharged through an outlet.

It is possible to minimize resistance of air discharged through an outlet.

It is possible to prevent air discharged through an outlet from re-introducing into an inlet.

It is possible to prevent vortex flow in a region near an outlet.

It is possible to provide an air cleaner with improved installation convenience for a worker.

The effects of embodiments are not limited to the effects mentioned above, and other effects not mentioned would be clearly understood from the claims by those who skilled in the art.

Desirable embodiments are described and illustrated above, but embodiments are not limited to the specific embodiments disclosed above and can be variously modified within the scope of the claims without departing from the essence of the invention as understood by those skilled in the art to which the invention pertains. These modifications should not be understood beyond the technical scope or concepts of the invention as described or anticipated and should not be understood individually from the technical concepts and perspective of the invention.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air cleaner comprising:
a first body that includes an inlet at a peripheral surface of the first body and an outlet disposed above the inlet;
a second body disposed above the first body and configured to guide air from the outlet in an outward direction, wherein the second body includes:
a lower cover disposed above the outlet and extending upwardly;
a top cover disposed above the lower cover;
an upper cover disposed between the lower cover and the top cover, and including a plate and at least one protruding cover that protrudes upward from the plate,
wherein the top cover includes a hole to receive the at least one protruding cover,
wherein the plate includes at least one groove that is depressed downward at a periphery of the at least one protruding cover.

2. The air cleaner of claim 1, wherein the at least one protruding cover includes a plurality of protruding covers spaced apart from each other at the plate, and wherein the at least one groove includes a plurality of grooves that are depressed downward at the periphery of the plurality of protruding covers.

3. The air cleaner of claim 2, wherein the plate includes a connection groove that is depressed downward at the plate, and the connection groove is to connect to each of the plurality of grooves.

4. The air cleaner of claim 3, wherein an area formed by the connection groove is larger than an area formed by each of the plurality of grooves.

5. The air cleaner of claim 3, wherein a downward depth of the connection groove is longer than a downward depth of each of the plurality of grooves.

6. The air cleaner of claim 3, wherein the plurality of grooves are spaced apart from each other in a circumferential direction, and wherein the connection groove is disposed between each of the plurality of grooves.

7. The air cleaner of claim 1, wherein a plurality of magnetic members are disposed at the top cover or at the upper cover, and wherein the hole is disposed between the plurality of magnetic members.

8. The air cleaner of claim 7, wherein the plurality of magnetic members include:
a plurality of first magnetic members spaced apart in a circumferential direction to form a virtual circle; and
a plurality of second magnetic members spaced apart in a circumferential direction on a concentric circle having a different radius from the circle formed by the plurality of first magnetic members.

9. The air cleaner of claim 1, wherein the top cover includes a cover plate disposed above the upper cover and a boundary wall that extends downwardly at an outer periphery of the cover plate, and wherein the boundary wall is disposed outside of a peripheral surface of the lower cover.

10. The air cleaner of claim 9, wherein the lower cover has a bowl shape that forms a space in which electronic units are to be disposed,
wherein the lower cover includes an edge rib that forms an outer wall at an upper end of the lower cover, and a plurality of partition ribs that extend upward from an upper surface of the lower cover and the partition ribs having different radii, and
wherein the boundary wall is disposed at an outer periphery of the edge rib.

11. The air cleaner of claim 10, wherein the plurality of partition ribs include a first partition rib disposed to face the edge rib, and wherein an outer end of the upper cover is disposed between the edge rib and the first partition rib.

12. The air cleaner of claim 1, wherein an area formed by an upper surface of the top cover is larger than an area formed by the outlet.

13. An air cleaner comprising:
a first body that includes an inlet to receive air from a peripheral surface of the first body and an outlet disposed above the inlet; and
a second body disposed above the first body and configured to guide air discharged from the outlet in an outward direction, wherein the second body includes:
a lower cover disposed above the outlet and extending upwardly;
a top cover that is separably disposed from the lower cover, and the top cover having a hole; and
a hole cover disposed to be inserted into the hole at the top cover, wherein the hole cover includes an upper hole cover to be disposed at the hole, and a lower hole cover that extends in a radial direction at an outer periphery of the upper hole cover, and the lower hole cover to be disposed under the top cover and that forms a groove depressed downward.

14. The air cleaner of claim 13, wherein the hole cover includes a connection plate that extends outward from the lower hole cover, and that the connection plate is mounted on the top cover.

15. The air cleaner of claim 14, wherein a magnetic member is disposed at the connection plate, and the magnetic member is configured to make the hole cover to contact to the groove formed at the top cover.

16. The air cleaner of claim 14, wherein the connection plate is attached to a lower surface of the top cover.

17. An air cleaner comprising:
a first body that includes an inlet and an outlet disposed above the inlet;
a second body disposed above the first body and configured to guide air discharged from the outlet in an outward direction, wherein the second body includes:
a lower cover disposed above the outlet, and the lower cover having a bowl shape configured to accommodate electronic units; and
an upper cover disposed above the lower cover, wherein the lower cover includes:
a guide wall disposed above the outlet and having a diameter that expands as the guide wall extends upward;
an edge rib that protrudes upwardly from an upper end of the guide wall; and
a plurality of partition ribs that extend upwardly from an upper surface of the guide wall, each of the plurality of partition ribs is to extend in different radial directions, wherein the plurality of partition ribs include a first partition rib disposed to face the edge rib, and wherein an outer end of the upper cover is disposed between the edge rib and the first partition rib.

18. The air cleaner of claim 17, wherein the second body further includes a top cover configured to be separable from the lower cover, and wherein the top cover includes a boundary wall extending downwardly from an outer end of the top cover and is disposed outside of an outer surface of the lower cover.

19. The air cleaner of claim 18, wherein a plurality of magnetic members are disposed at the top cover or at the upper cover.

20. The air cleaner of claim 18, wherein the upper cover includes a plate and a protruding cover, the protruding cover to protrude upward from the plate and to be received in a hole at the top cover.
